(19) United States
(12) Patent Application Publication
(10) Pub. No.: US 2004/0044554 A1
(43) Pub. Date: Mar. 4, 2004

(54) Methods and systems for managing field personnel and projects through a wireless network

(76) Inventors: Christopher Bull, Dallas, TX (US); Yaser Abdullah Mowafi, Plano, TX (US)

Correspondence Address: KERMIT D. LOPEZ/ LUIS M. ORTIZ, ORTIZ & LOPEZ, PLLC, PATENT ATTORNEYS, P. O. BOX 4484, ALBUQUERQUE,, NM, 87196-4484, US

(21) Appl. No.: 10/228,599

(22) Filed: Aug. 27, 2002

(51) Int. Cl. G06F 17/60

(52) U.S. Cl. 705/8

(57) ABSTRACT

Methods and systems for managing dispatcher and technician work order information through a wireless network are disclosed herein. A database for storing work order information can be provided. Additionally, a graphical user interface displayable at a display screen of a data-processing system can be utilized by a dispatcher to enter work, transmit and receive work order information to and from a technician through a wireless network. A mobile device interface displayable at a display screen of a mobile wireless device, is also provided which permits the technician to enter, transmit and receive the work order information to and from the dispatcher through the wireless network. The database can be accessed by the dispatcher utilizing the graphical user interface and/or by the technician utilizing the mobile device interface.

### TECHNICAL FIELD

The present invention is generally related to wireless communication networks. The present invention is also related to graphical user interface (GUI) and mobile device interface (MDI) technologies. The present invention is additionally related to cellular telephone and personal digital assistant (PDA) devices. The present invention is additionally related to methods and systems for transmitting information to and from dispatchers and technicians in a service business environment.

### BACKGROUND OF THE INVENTION

It is often difficult to ensure that technicians receive accurate work order information on a timely basis in service industries where dispatchers must communicate information to field personnel (i.e., field technicians). Because of the difficulty in accurately referring a constant influx of new information to technicians in the field, appointments can be missed resulting in delays and inefficiencies. The ability to receive information efficiently and timely can make or break a service industry based business. Examples of such businesses include pest control services, heating and air conditioning installation and repair services, landscaping, plumbing and so forth.

Presently, dispatchers must use a telephone to call a technician and provide current work order information. Oftentimes, the technician is forced to go to a central location to receive current work order information, resulting in loss of time and inefficiency. If a technician instead possessed remote access to necessary work order information using a wireless communicator, the technician would not be forced to lose valuable time driving to a central location to obtain current work information, such as appointments, schedules, times, dates, and so forth.

Electronic means for organizing and relaying information to field personnel have been attempted. One of the problems with such electronic methods and systems is that they are not seamless in operation. Field personnel typically are unable to communicate with more than a few text messages back to a central dispatcher. Such messages are not coordinated with matching database information. Current methods and systems also do not present adequate graphical user interfaces and mobile device interfaces at both the dispatcher side and technician side. Additionally, current methods and systems have difficulty in coordinating with present wireless communications networks. Also, existing dispatcher based software and systems do not readily coordinate with technician mobile devices, such as cellular telephone and wireless PDA devices. In addition, existing wireless dispatcher systems do not support all functions and features using a “relatively” inexpensive mobile phone device in the same manner and format in which they function using PDA devices. Additionally, existing services are mainly provided through ASP wireless field service applications that do not leave any room for end user configuration based on business rules and functionality requirements.

The present inventors have thus concluded that a need exists for improved methods and systems for managing field personnel and projects utilizing wireless data and communications networks. The present inventors believe that if such a need can be met, field personnel will be able to coordinate work order information, including scheduling and appointments with dispatchers much more efficiently than solutions being offered by current systems. Components such as scheduling spare parts, tracking, and so forth could thus be readily and efficiently managed.

### BRIEF SUMMARY OF THE INVENTION

The following summary of the invention is provided to facilitate an understanding of some of the innovative features unique to the present invention, and is not intended to be a full description. A full appreciation of the various aspects of the invention can be gained by taking the entire specification, claims, drawings, and abstract as a whole.

It is therefore one aspect of the present invention to methods and systems for managing field personnel (i.e., technicians) and projects (i.e., work orders) through a wireless network.

It is therefore another aspect of the present invention to provide a graphical user interface (GUI), which permits a dispatcher to transmit and receive work order information to and from a wireless mobile device associated with a technician.

It is yet another aspect of the present invention to provide an improved mobile device interface (MDI).

The above and other aspects of the invention can be achieved as will now be described. Methods and systems for managing dispatcher and technician work order information through a wireless network are disclosed herein. A database for storing work order information can be provided. Additionally, a graphical user interface displayable at a display screen of a data-processing system can be utilized by a dispatcher to enter work order information, transmit and receive work order information to and from a technician through a wireless network. A mobile device interface displayable at a display screen of a mobile wireless device can also be provided that permits the technicians to enter, transmit and receive the work order information to and from the dispatcher through the wireless network. The database can be accessed by the dispatcher utilizing the graphical user interface and/or by the technician utilizing the mobile device interface.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 illustrates a high-level system architecture and diagram depicting logical operational steps that can be implemented in accordance with preferred embodiments of the present invention;

FIG. 2 depicts a ticket summary window, which can be implemented in accordance with a preferred embodiment of the present invention;

FIG. 3 illustrates a ticket detail window, which can be implemented in accordance with a preferred embodiment of the present invention;

FIG. 4 depicts an add ticket event window, which can be implemented in accordance with a preferred embodiment of the present invention;

FIG. 5 illustrates a standard comments window, which can be implemented in accordance with a preferred embodiment of the present invention;

FIG. 6 depicts a user profile window, which can be implemented in accordance with a preferred embodiment of the present invention;

FIG. 7 illustrates a report generator window, which can be implemented in accordance with a preferred embodiment of the present invention;

FIG. 8 depicts a customer detail window, which can be implemented in accordance with a preferred embodiment of the present invention;

FIG. 9 illustrates a purge criteria window, which can be utilized in accordance with a preferred embodiment of the present invention;

FIG. 10A depicts a high-level flow chart of operations illustrating logical operational steps for implementing a mobile device interface (MDI), which can be executed in accordance with a preferred embodiment of the present invention;

FIG. 10B illustrates continued a high-level flow chart of operations illustrating logical operational steps for implementing a mobile device interface (MDI), which can be executed in accordance with a preferred embodiment of the present invention;

FIG. 11 depicts a pictorial diagram of a data-processing system, which can be utilized by a dispatcher in accordance with a preferred embodiment of the present invention may be implemented;

FIG. 12 illustrates a block diagram of the components for the data-processing system depicted in FIG. 11; and

FIG. 13 depicts a client-server based system, which can be utilized in accordance with a preferred embodiment of the present invention.

### DETAILED DESCRIPTION OF THE INVENTION

The particular values and configurations discussed in these non-limiting examples can be varied and are cited merely to illustrate an embodiment of the present invention and are not intended to limit the scope of the invention.

The present invention provides methods and systems for managing field personnel and projects through a wireless network. A variety of functionalities can be provided utilizing both personal computers and wireless mobile devices. A dispatcher functionality or dispatcher component can be provided from a desk top personal computer, which permits a user to create a ticket, assign a dispatch, update a ticket, and monitor workload. A technician functionality or technician component can be provided through a wireless mobile device, which permits a user to acknowledge a dispatch, indicate drive and arrival statuses, complete/incomplete a ticket, reschedule services, and add comments. Additionally, the present invention provides administrator functionality from a desktop personal computer including the ability to maintain standard comments, reason codes, and system parameters.

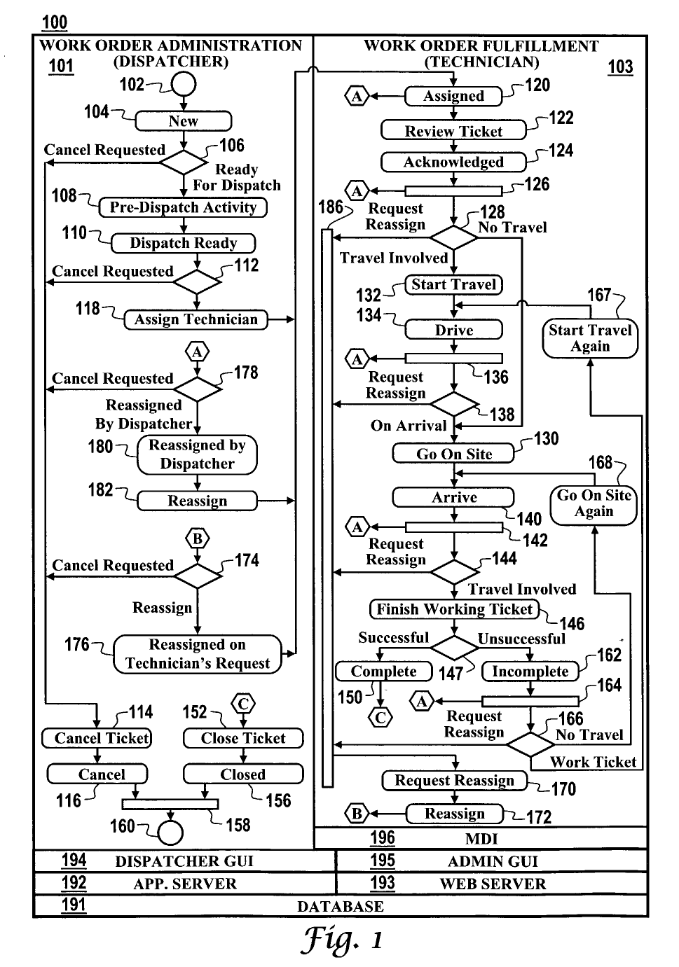

Referring to FIG. 1, a system architecture and associated methodologies for managing field personnel and projects are illustrated. The invention described herein can be implemented to include a dispatch database 191, dispatch application server 192, a dispatch web server 193, a dispatcher graphical user interface 194, an administrator graphical user interface 195 and a dispatch technician mobile device interface (MDI) 196. The dispatch database 191 is utilized to hold the dispatch information in a central location to be read by the various dispatch personnel. The dispatch application server 192 is utilized to support real-time communications between the dispatch database 191 and the dispatchers, dispatch technicians, and legacy systems. The dispatch web server 193 can provide access and communication management of the system with wired/wireless data networks. It should be appreciated that the dispatch application server 192 and dispatch web server 193 can be provided as a single server.

The dispatcher graphical user interface 194 can enable office personnel to create, view, and update tickets, and to assign one or more dispatch technicians to those requests. The administrator graphical user interface 195 can be used to maintain the system tables, users and archives. MDI (Mobile Device Interface) 196 is generally utilized by technicians to remotely view and update assigned dispatches.

A number of dispatcher functional requirements can be implemented in accordance with the methods and systems described herein. One such dispatcher functional requirement is dispatcher authentication. For example, a dispatcher logon window can be provided to capture a user's ID and password and validate the dispatcher database to ensure that only authorized users can access the application data. Other authentication hardware and software can be utilized in accordance with the present invention to achieve user authentication. For example, biometric authentication can be used to authorize system access by a user (e.g., dispatcher and/or field technician).

Another dispatcher functional requirement is the ability to provide a ticket summary. Ideally, the dispatcher should be able to view a summary of all tickets in the database. Individual tickets are generally color-coded according to their status. The dispatcher can utilize the summary information to monitor the progress of tickets assigned to technicians. The invention described herein also provides the ability for a user to generate reports. For example, specific reports can be provided so that information concerning tickets and dispatches can be viewed and stored in concise and orderly formats.

The dispatcher can filter and/or sort data by customer Information, due date, ticket status, technician, and so forth. The ticket summary will likely be the most frequently used area in the dispatcher component. Another dispatcher functional requirement can permit a dispatcher to view the last update to a user ID by capturing, storing and displaying the user ID of the person who made the most recent update to any ticket. The dispatcher can also be permitted to create a new ticket and view outstanding technician dispatches. The dispatcher can view current open dispatches associated with a particular technician.

The dispatcher can selectively display additional details about the ticket namely, customer information and ticket event summary from the ticket summary. In the event that the dispatched technician is not able to utilize his or her mobile device, the dispatcher can update the status of a particular ticket. Some events such as Assign, Cancel and Close can be managed only by a dispatcher.

The ticket event detail can provide information about any one ticket event and its comments. In order to quickly respond to inquiries the dispatcher will need the ability to locate tickets in the database by a variety of parameters like customer information, technician information, order information, due date, etc. Additionally, the dispatcher should be able to browse through the list of users in the system to visually locate a particular user. A dispatcher with administrative authority can update the user profile of the specified user. The user is permitted, however, to maintain user privileges. The dispatcher possessing administrative authority can add a new dispatcher or dispatch technician to the system. The dispatcher can add a new customer or update an existing customer. The dispatcher can also quickly locate a particular customer in the database by searching it using information about the customer, such as: customer ID, business name, first/last name, phone number, address, and so forth.

Users with sufficient authority (i.e., administration privileges) can update system tables and/or system flags. A variety of tables, including a comment table and a reason table, can be maintained utilizing a system maintenance area, which is displayable via the graphical user interface. Particular system level flags can be maintained utilizing such a system maintenance area. For example, event type flags can indicate that the business chooses to utilize certain optional ticket event types. SMS Flags can be utilized to determine the default for a Send SMS Message check box when dispatcher makes changes to tickets. An Auto Close Ticket Flag can indicate, for example, if the event type of ‘Closed’ is automatically created when the technician creates an event type of ‘Complete’. Dispatcher Alert Values/Flags indicate if alert icons should be displayed on the dispatcher graphical user interface. Dispatcher Create/Edit Technician Events can be utilized to determine if the dispatcher can create or edit ticket events that are normally created by the technician.

The technician can be provided with a number of options, including a time stamp override, which is generally a flag that determines if the technician can edit the time stamps on the ticket events in cases where the technician is unable to update in real time due to lack of wireless coverage. A Ticket Due Date is a flag that can determine if the technician can edit ticket due dates.(i.e., appointment times). A Create Auto Alert is a flag that can determine if a dispatcher should be automatically alerted when a technician adds a comment.

A variety of other flags can be provided, in accordance with the methods and systems described herein, including a customer preference flag, which can be utilized to determine if the business tracks customer accounts. If the flag is set to ‘No’ then the system will generate customer identification numbers. If it is set to ‘Yes’ the user will be required to provide a customer identification number.

Purge options can also be made available to provide the default period for purge records in the database. A customer purge can be implemented to purge customer accounts having no activity for a specified period of time. If a customer account is blank, however, associated records do not have to be purged. A ticket purge can be implemented, such that tickets with closed dates less than the specified date are purged along with the associated ticket events, comments and reasons. If it is blank then no tickets will have to be purged.

Event Data Entry Flags indicate if additional data may be required for a particular event type. Additionally MDI Title Preferences can be utilized to determine what is displayed in the title of the mobile device for certain screens after a ticket has been selected. Finally an owner profile can be implemented, while includes a profile of the company owning the software license.

A number of reports can be generated from the operational data captured as part of the dispatch activities, including a summary/detail of closed tickets dispatched by a dispatcher, a summary/detail of closed tickets worked by a technician, a summary/detail of Incomplete dispatches by technician and reason code, a summary/detail of reassigned dispatches by technician and reason code, a summary/detail of cancelled tickets by dispatcher and reason code, and a summary/detail of open tickets for a technician as of a certain date.

Interval calculations can be based on the Event Create Date/Time of successive ticket events as indicated below:

Travel Time=(Event Create Date for Ticket Event Type=Arrive)−(Event Create Date for Ticket Event Type=Drive).

On Site Time=(Event Create Date for Ticket Event Type=(Complete or Incomplete or Reassign or Yanked))−(Event Create Date for Ticket Event Type=Arrive).

Total Technician Time=(Event Create Date for Ticket Event Type=(Complete or Incomplete or Reassign or Yanked))−(Event Create Date for Ticket Event Type=Acknowledged).

Technician Time to Acknowledge=(Event Create Date for Ticket Event Type=Acknowledge)−(Event Create Date for Ticket Event Type=Assigned).

Time to Dispatch=(Event Create Date for Ticket Event Type=Assigned)−(Event Create Date for Ticket Event Type=New).

Time to Close=(Event Create Date for Ticket Event Type=Complete)−(Event Create Date for Ticket Event Type=Closed).

Total Ticket Time to Close=(Event Create Date for Ticket Event Type=Closed)−(Event Create Date for Ticket Event Type=New).

The dispatched technician or dispatcher can thus manually make changes to the ticket status by creating new events based on the rules discussed later. A new event can be created as long as the event type is advancing. No backward moves should permitted.

A number of dispatched technician functional requirements can also be implemented in accordance with the method and system disclosed herein. Such requirements include a technician logon (which can include authentication using biometrics or passcodes), ticket summary, ticket detail and ticket event summary, ticket event detail, ticket comment summary, ticket event reason selection, and standard comment selection. The technician logon screen should capture the user identification and the password/biometric and validate the information against a database to ensure that only authorized users can access the applications/data.

The technician should be able to view a summary of all tickets assigned to him or her. The technician can use the summary information to prioritize and work tickets. The technician can sorts by due date+ticket status. The ticket summary may be the most frequently used area in the technician component. The technician can further be provided with the ability to selectively display additional details about the ticket, namely, customer information and ticket event summary from the ticket summary. The technician can also be provided with the ability to update the status of the ticket by creating a ticket event with the appropriate status. Additionally, the technician can update the Meet Date/Time and Meet Time Range of the ticket based on system parameters.

The Ticket Event Detail should generally provide information about the status and the event date/time. The Technician can update the status of the Ticket by creating a Ticket Event with the appropriate status. The Technician can input mileage when applicable to indicate the number of miles he had to travel to get to the customer site. The Ticket Comment Summary should list a history of comments associated with a particular ticket. When the Technician changes the status of a ticket he/she can associate a reason code. Finally, when the Technician wishes to convey a message to the dispatcher relating to a ticket he/she can select or enter a comment.

A number of communications can be transmitted to dispatched technicians. For example, New Ticket Alerts and Updated Tickets/Ticket Events can be provided. At the time a Ticket is assigned to a technician a new ticket alert message can be sent to the technician if the dispatcher so chooses. The dispatch technician can receive a text message on his mobile device when the dispatcher has assigned him a new ticket. New tickets can be delivered to dispatched technicians at the time they log into applications using their mobile devices.

At the time a Ticket is updated by the dispatcher, an updated ticket message can be sent to the technician if the dispatcher so chooses. The dispatch technician can receive a text message on his mobile device. Updated tickets can be delivered to the dispatched technician at the time they log into the application using their mobile phones. Additionally updated ticket events can be generated. A variety of events initiated by the dispatch technician can trigger updates to the dispatch database. An initial review of the dispatch can automatically change the status of the dispatch to ‘Acknowledged’ and trigger an update of the database. Other events, which can trigger updates to the dispatch database, include, ticket event adds/updates, the additions of comments, and/or ticket meet date/time and range updates

The values for the status of a ticket represent all possible steps during the lifecycle of a request. The status for a ticket can be determined based upon the Ticket Event Type of the most recent Ticket Event. There are two types of Ticket Event Types: Dispatcher Ticket Event Types and Technician Ticket Event Types. Dispatcher Ticket Event Types include those that are new, meaning that technician has not yet been assigned, and those that are dispatch ready, meaning that the ticket is ready to be dispatched. Dispatch ready events are utilized in case the tickets are entered in the system by one person and are dispatched by another person. Dispatcher Ticket Event Types also include those that are cancelled, meaning that the dispatcher has determined that a ticket is invalid and no longer wants it displayed or worked by any dispatch technician. Dispatcher Ticket Event Types also includes those that are closed.

Technician Ticket Event Types can include those that are assigned, meaning that a technician has been assigned, but not yet acknowledged by the technician. Technician Ticket Event Types can also include those that have been acknowledged, meaning that the technician has reviewed the request. This particular event can be created by the system when a technician reviews a ticket that has been assigned to him or her. Technician Ticket Event Types can also include those which can be labeled “Drive,” meaning that the dispatch technician has begun traveling to the customer location, or those which can be labeled “Arrive,” meaning that the dispatch technician has arrived at the customer location and has begun work.

Additionally, Technician Ticket Event Types can be considered “Yanked,” “Completed,” “Incomplete,” or “Reassigned.” A yanked event is one in which the dispatcher has removed the ticket from a particular technician's queue. A completed event is one in which the dispatch technician has finished all work and made all updates. An incomplete event is one in which the dispatch technician has not finished the required activities. Finally, a reassigned event can be indicated where a technician is not qualified (or does not have time) to complete a particular work order.

FIG. 1 also illustrates a high-level flow chart 100 of operations depicting logical operational steps, which can be implemented with a system 100 in accordance with a preferred embodiment of the present invention. Flow chart is divided into two sections, a dispatcher section 101 and a technician section 103. Dispatcher section 101 involves work order administration, while technician section 103 involves work order fulfillment. Continuation or connecting blocks A, B and C are also indicated in FIG. 1 to represent points of continuous logical operational flow. The process begins, as indicated at block 102. Thereafter, as depicted at block 104, a new work order can be initiated. As illustrated next at decision block 106, a decision is made whether or not to begin pre-dispatch activities, as indicated at block 108, or cancel a request for a new work order or ticket, as indicated at block 114. If it is determined to begin pre-dispatch activities, then the pre-dispatch operation depicted at block 108 is processed.

Following processing of the operation described at block 108, a dispatch ready activity is processed. As indicated next at decision block 112, a decision is made determining whether or not to cancel the request, in which case the ticket is subsequently canceled as illustrated at block 114, or to confirm the work order (i.e., ticket) and assign it to a technician, as illustrated at block 118. If the work order is confirmed, then the ticket is assigned to the technician, as indicated at block 118. Following processing of the operation described at block 118, the ticket receives the ticket, as indicated at block 120. At this point in the process, the ticket can be cancelled or reassigned, as illustrated by connector A and decision block 178. The dispatcher, as depicted at blocks 180 and 182, can reassign the ticket.

The ticket can thereafter be assigned to a new technician, as indicated at block 120. The ticket can also be cancelled, as illustrated at blocks 178 and 114. Alternatively, the technician can simply review the ticket, as described next at block 122 and thereafter, as indicated at block 124, acknowledge the receipt of the ticket (i.e., work order). Following processing of the operation described at block 124, several alternative operations may be performed, as indicated by router bar 126 and decision block 128. The technician can begin travel, as indicated by blocks 132 and 134, or the technician may not have to travel, because the technician is already on site, as indicated by block 130. The technician can also request to be reassigned, as indicated by decision block 128 and router bar 186. If the technician, for example, drives to the site, as indicated at blocks 132 and 134, then several options are available, including, for example, cancellation of the ticket, as indicated sequentially by router bars 136, connector A (i.e., which follows router bar 136) and decision block 178.

Upon arrival, as indicated by decision blocks 138 and 130, the technician can go directly to the site requiring servicing or maintenance. Arrival at the site can then be confirmed, as illustrated at block 140. Following confirmation of arrival at the site, a number of options are then available, as indicated by router bar 142 and decision block 144. The original ticket can still be cancelled as indicated sequentially at router bar 142, connector A (i.e., which follows router bar 142), decision block 178 and block 114, or reassigned to another technician by the dispatcher, as indicated sequentially at router bar 142, connector A, decision block 178 and block 180. Following processing of the decision operation illustrated at decision block 144, the technician can simply finish working the ticket, as indicated at block 146. Alternatively, the technician can request that the ticket be assigned to another technician, as indicated sequentially at decision block 144 and router bar 186.

A decision block 147 follows the operation indicated at block 146. A confirmation can then be generated to indicate if the operation was successful (i.e., or unsuccessful), as indicated at decision block 147. If the operation was successful and thus complete, as illustrated at block 150, the operation continues as shown at a continuation block or connector C and the operation subsequently depicted at block 152 (i.e., “Close Ticket”). If the operation was unsuccessful and thus incomplete, as illustrated at block 162, a number of options are available, as indicated by router bar 164. The technician can request a reassignment, as indicated at connector A, and subsequent operational steps (e.g., blocks 178, 180 182, etc.). Alternatively, a decision operation can be processed, as illustrated at block 166. Several possible operations may follow processing of the decision operation indicated at block 166. A routing operation may be processed, as indicated by router bar 186. The technician can also be provided with a new work ticket and travel again to a new site, as indicated by blocks decision block 166, block 167 and block 134. The technician can also go on site again, as indicated by decision block 166 and block 168.

Following processing of operations linked to router bar 186, the technician can also request reassignment of the ticket, as indicated at blocks 170 and 172. A continuation block or connector B follows block 172 to indicate a continuation to decision block 174. As indicated at decision block 174, the dispatcher can reassign the technician to a new ticket as illustrated at block 176, or the ticket simply cancelled, as indicated at blocks 114 and 116. The process can then terminate, as indicated by router bar 158 and block 160. The technician can alternatively provide wireless feedback to the dispatcher that the ticket is complete, as indicated at block 150. The ticket can then be closed by the dispatcher, as illustrated at blocks 152 and 156. Following closing of the ticket, the entire process can then be terminated, as indicated by router bar 158 and endpoint 160.

It can be appreciated by those skilled in the art that the present invention can be implemented as a program product (i.e., computer program product) composed of one or more modules. The term “module” as utilized herein thus generally refers to a software module. In the computer programming arts, a module can be implemented as a collection of routines and data structures that performs particular tasks or implements a particular abstract data type. Modules generally are composed of two parts. First, a software module may list the constants, data types, variable, routines, and so forth that can be accessed by other modules or routines. Second, a software module may be configured as an implementation, which can be private (i.e., accessible only to the module), and which contains the source code that actually implements the routines or subroutines upon which the module is based. Thus, when referring to a “module” herein, the present inventors are referring so such software modules or implementations thereof.

It can be appreciated by those skilled in the art the methodologies illustrated in FIG. 1 for example, can be implemented as a series of modules. Such modules can be utilized separately or together to form a program product that can be implemented through signal-bearing media, including transmission media and recordable media. The present invention can thus be implemented as a program product composed of a plurality of such modules, which can be interactively displayed for a user on a display screen of a data-processing system (e.g., computer). Such interactivity can be provided by a graphical user interface (GUI), which is well known in the art.

A graphical user interface is a type of display format that enables a user to choose commands, start programs, and see lists of files and other options by pointing to pictorial representations (icons) and lists of menu items on the screen. Choices can generally be activated by either a keyboard or a mouse. For application developers, graphical user interfaces offer environments that handle direct interaction with the computer. Such environments free the developer to concentrate on a given application without becoming entangled in the details of a screen display or mouse and keyboard input. A graphical user interface also enables programmers to create programs to handle frequently performed tasks, such as saving a data file. The interface itself provides standard controlling mechanisms such as windows and dialog boxes. Another benefit of graphical user interfaces is that applications written for graphical user interfaces are device independent: as the graphical user interface changes to support new input and output devices, such as a large screen monitor or an optical storage device, the applications can, without modification, use those devices. Thus, an important aspect of virtually every conventional personal and business computer is the graphical user interface. It is, primarily, the graphical user interface that the user employs to interact with the computer. Typically, the graphical user interface can include an electronic desktop, windows, icons and pull-down as well as pop-up menus.

The majority of computer system users today work with computers that run some type of graphical user interface operating system, such as Windows 2000, developed by Microsoft® Corporation of Redmond, Washington or the windows-enabled operating system found on the Apple Macintosh® Computer developed by Apple Computers of Cupertino, Calif. These operating systems can execute many application programs, including threads, simultaneously (i.e. multitasking). These applications can perform specific tasks, such as, for example, word processing, database management, spreadsheet calculations, etc. Such GUI-oriented operating systems are all generally based on the concept of a window. The “window” is the basic unit of the graphical user interface and the user interacts with applications through one or more windows. Text and pictures (e.g.,. bitmaps, jpegs, etc.) are among the basic units of information with which the user works while interacting with the graphical user interface. Thus, when utilizing the term “window” as described herein, the present inventors are referring generically to this type of a “window.” The window typically encompasses a portion of the computer display. Most often, it is a rectangular shaped area in which the user can, for example, view information relating to folders and files; interact with software applications; and execute programs. Of course, windows can be opened, closed and physically moved within the computer display. Note that although the present invention is discussed in terms of “windows” technologies, it can be appreciated that the present invention can also be implemented in a web-based environment and operate from a web browser utilizing frames. For example, the dispatcher application described can be implemented entirely utilizing web-based frames. Note that as utilized herein, the term “frames” generally refers to a feature well known in the networking arts that is supported generally be web browsers, which permits a Web-site creator to divide a browser display into two or more sections (i.e., frames). The contents of each frame can be taken from a different web page. The use of windows-based technologies thus does not represent a limiting feature of the present invention.

In general, the invention described herein can include a number of design characteristics, which can be implemented according to desired applications. For example, it can be assumed that an open ticket is one that has a most recent ticket event with status equal to New, Dispatch Ready, Assigned, Acknowledged, Drive, Reassign, Arrive, Yanked, Complete or Incomplete. A finished ticket, on the other hand is one that possesses a ticket event with a status equal to Cancelled or Closed characteristic. Updates can be performed by a dispatched technician user, such as the status or adding comments are communicated to the central database. Changes can be saved and communicated by a dispatcher utilizing a summary window, in which the user makes or confirms a change.

Changes can also be saved and communicated utilizing other means, such as another window when the user saves the changes. If a user exits any window without saving changes, the user can be prompted with the words “Save changes?” along with Yes, No, and Cancel graphical user interface buttons. Several fields can be updated whenever a dispatcher or dispatched technician updates either the ticket or one of the ticketed events. These fields include a “Ticket Last Update Date/Time” field, which provides the current time when the user “saves,” and a “Ticket Last Update User ID” field, in which information concerning the current user is entered and/or saved. All windows (i.e., graphical user interface) can be provided with a toolbar to simplify access to appropriate menu options.

The dispatcher can view tickets utilizing a Dispatcher Logon Window, which can capture a user identification number and password and validate this information against the database. The following fields can be displayed: User Id and Password/Biometric. The window can also display an OK and a Cancel button. Clicking the OK button utilizing, for example, a mouse, will validate the data entered and if successful will open the Ticket Summary Window. If unsuccessful a message will be displayed. Clicking the Cancel button will exit the application.

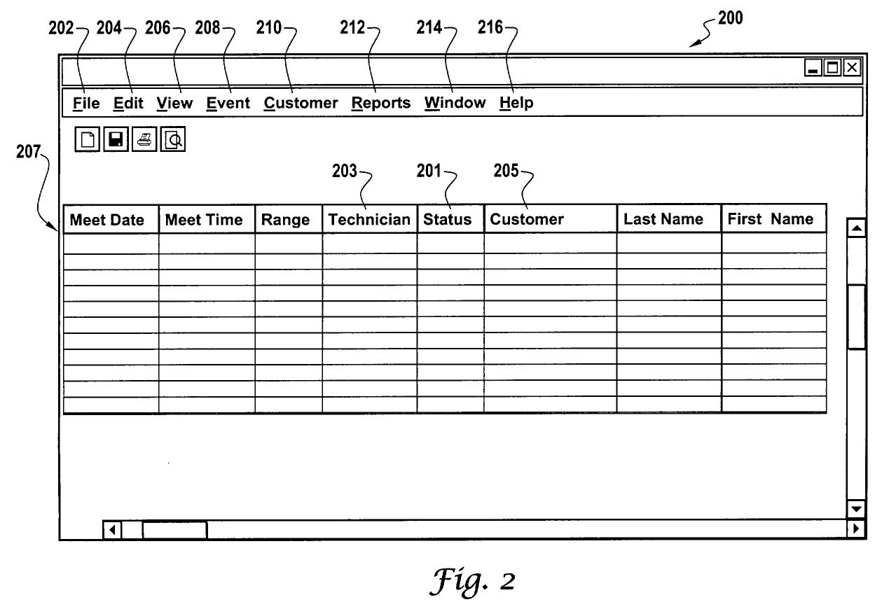

FIG. 2 depicts a ticket summary window 200, which can be implemented in accordance with a preferred embodiment of the present invention. Window 200 can function as the main window for a dispatcher user. In a web-based environment implement utilizing frames, for example, window 200 would always remain open. Window 200 can possess a number of characteristics. For example, The Ticket Event Type of the most recent Ticket Event determines the Ticket Status 201. Every ticket has at least one event 207, dispatcher 203, and a customer 205 associated with it. A number of Ticket Event Types are possible, such as New, Dispatch Ready, Assigned, Acknowledged, Drive, Arrive, Yanked, Complete, Incomplete, Cancelled, Reassign, and Closed.

The tickets can be sorted by ticket priority, except that tickets with no ticket priority (or blank) are last in the display. The secondary sort is the ticket-scheduled date. Tickets can be resorted by clicking on any column on the display. A number of fields can be displayed via window 200 or another window, including the ticket number, the ticket priority 203, ticked status 207 (i.e., derived from the event type of the most recent Ticket Event), a user short name (e.g., a technician assigned to the ticket), a customer business name, a first name/last name, phone/extension, mobile telephone number, fax number, e-mail address, street, city, and zip. If more than one ticket event exists for a ticket, the ticket status and the technician short name should come from the event with the greatest create date/time.

The following Ticket Event statuses 201 can be presented to the user using color codes to signify that dispatcher attention is required: New, Complete, Incomplete, Yanked, Cancelled and Reassign. Note that these colors should generally be different from the color of a selected row. Particular timing alerts can be displayed next to the relevant row. For exampled, tickets not acknowledged x, y, and z hours from the assigned date/time where x, y and z are system parameters, e.g., 6/12/24 Hours (Status=Assigned); excessive time on-site A, B, and C hours from Arrived date/time where A, B and C are system parameters, e.g., 30/60/180 Minutes (Status=Arrive); Past Due (Current Date/Time>Meet Date/Time+Range and Status < > Complete, Closed or Cancel). The technician can be alerted if the most recent technician comment has the alert set.

A number of menu options can be associated with window 200, including File, Edit, View, Event, User, Customer, Reports, Window and Help. The File menu option 202 can include New, Open, Lookup, Print, Purge, Import, Refresh, and Exit. The New option can allow a dispatcher user to open a blank Ticket Detail window in an add mode. The Open option can permit the user to open the Ticket Detail Window for a selected row. A Lookup option thereof can permit the user to open a window and list all the searchable fields and an OK and Cancel buttons. An OK button or option can open Ticket Detail Window for the entered information. If more than one ticket matches the criteria open a window that presents the user with a list of those tickets with OK and Cancel buttons. Selecting a row and clicking OK or double clicking a row will open Ticket Detail Window for the selected row. The Print option can permit a user to print ticket information for a selected row. The Purge option can permit a user to open a Purge Criteria Window. The Refresh option can allow the database to be reread and the window to be repopulated with appropriate data. The Exit option can allow a user to quit the application.

The Edit menu option 204 permits a user to edit particular data of interest. The View menu option 206 includes a Default Sort option (i.e., Priority+Scheduled Date and Time). The View menu also can include a View Open (Default) option, which provides a list of all open tickets. The View Finished option can permit a user to list all closed and cancelled tickets. A View All option can permit a user to list open and finished tickets. Additionally, the View menu can provide a customer filter, which can be provided via a dialogue box and permits a user to filter data based on the zip code, city, “from and to” ranges, and dispatcher identification data. The user can save his or her choice.

The Event menu option 208 allows a dispatcher user to add a dispatcher and/or technician event. The “Add Technician Event” option may be grayed if a system parameter disallows an event or if the most recent ticket event is one of the following event types: Assigned, Acknowledged, Drive, Arrive, and/or Incomplete. In addition, a user can edit an event utilizing the Event menu. The user can open a ticket event, which is grayed unless the system parameter is set to YES.

The User menu can provide a number of options, including Profile, New User, Lookup, List, and Change Password options. The Profile option can allow a user profile window to be opened for a logged-on user identification number. The New User option can permit a user to open a blank user profile window in add mode. The Lookup option can allow a search window to be with searchable fields and with OK and Cancel buttons. By activating the button labeled OK a user profile window can be opened for the entered search criteria namely, Short Name, User ID, and Last Name (i.e., partials allowed). If more than one user matches the criteria, a window can be opened that presents the user with a list of those users with OK and Cancel buttons. Selecting a row and clicking OK or double clicking a row can also open a user profile window for the selected row. The List option of the User menu can allow the user to open a User Summary Window. The Change Password option of the User menu can allow a window to be opened having the particular characteristics, including three fields with a masked input (i.e., old password, new password, and confirm new password) and two buttons, including an OK button that can verify old and new confirmations and a Cancel button that can allow the user to return to the previous window.

The Customer menu option 210 is available to track customer and can permit a user to add a customer, list customers and lookup customers. The Reports menu option 212 can allow a user to generate reports. By activating the Reports menu, a Report Criteria Window can be opened. The Window menu option 214 can allow a user to modify or chose standard options (e.g., tile, cascade, etc.). Finally, the Help menu option 216 can provide an index that launches context-sensitive help applications and “about” information regarding the current application. The “about” information can be displayed utilizing an informative dialog box with an OK button.

Clicking on an unselected row highlights and selecting that row with a mouse can handle events in the Ticket Summary Window. Any previously selected row can be un-highlighted and deselected. Events can also be handled by pressing the Enter key while a row is selected opens the ticket detail for that row, and double clicking on a row selects that row and opens the Ticket Detail for that row. Right button clicking on a row can select that row and brings up a pop-up menu that can include Add Dispatcher Event, Add Technician Event, View Details and View Tech Profile options. The Add Dispatcher Event option can open the Add Event pop-up. If an event is added the system can process the Alert to Technician based on the system parameter. The Add Technician Event option (may be grayed as discussed above) can open the Add Event pop-up. If an event is added the system can process the Alert to Technician based on the system parameters. The View Details option can open the Ticket Detail window for the selected row. Finally, the View Tech Profile option can open the User Profile Window for the technician user identification number of the most recent Event associated with the Ticket. This option can be grayed-out if the most recent Ticket Event is New, Dispatch Ready, Closed or Cancel. If a valid Event is added, changes can be made to the database and appropriate color updates to the display performed thereof. Also, any time the window regains focus from another window, the database can be reread and the window repopulated.

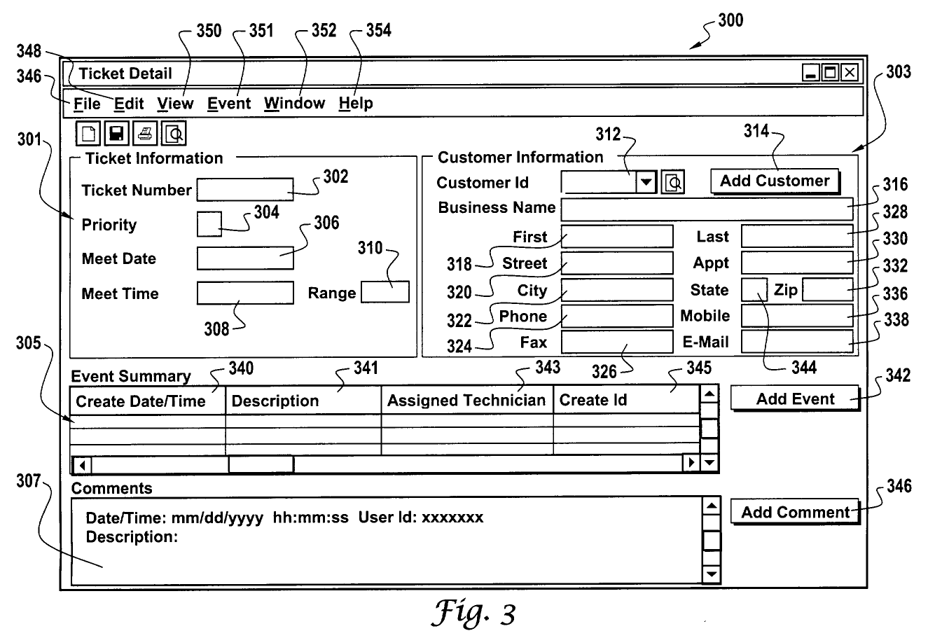

FIG. 3 illustrates a ticket detail window 300, which can be implemented in accordance with a preferred embodiment of the present invention. Window 300 can permit a dispatcher/user to create, read, and update a ticket and/or add an event. Multiple instances of this window may be open at a time. The display can include the following characteristics, including the title based on the Customer Name 311, 318, 328 (Business Name if available else Contact First Name/Last Name), and Ticket number 302. All data on the window is shown for a single Ticket. The customer ID number can be selected utilizing field 312. Pressing the Add Customer button 314 permits a user to add a customer. The fields can be organized into four sections, including a ticket section 301, a customer section 303, a ticket event section 305 and a ticket comment section 307. The Ticket Section 301 can be composed of ticket fields based on ticket number 302, ticket priority 304, meet date 306, meet time 308, and meet time range 310.

A ticket number field 302 can provide a unique number that is automatically generated by the system for a new ticket. For an existing ticket this field can be grayed out. A ticket priority field 304 can provide a single character field that signifies the priority of the ticket. (The user enters it, and it is can be in the form of an alphanumeric field.) A Meet Date field 306 can provide the scheduled date for the technician to go to the customer site. A Meet Time field 308 can provide the scheduled time for the technician to go to the customer site. The Meet Time Range field 310 can provide the range of time in hours when the customer will be available. If field 310 is left blank then it can be presumed that the appointment is for a fixed time. All Ticket fields are open for input (white) except the following display-only fields (grayed-out): Ticket Last Update Date and Ticket last update User ID.

The customer section 303 can provide the following Customer fields that are display-only fields (i.e., grayed-out): Customer Last Update Date and Customer last update User ID. If the System Parameter for Track Customer account is set to ‘Yes’ then for a new ticket, the Customer ID field 312 can be white and can provide a drop down list of all customer identification numbers in the system. All other customer related fields are grayed out. The user can enter a customer identification number 312 and if the customer exists associated fields can be populated and turn white and are editable. All changes made when saved can update the customer record. Such populated fields can include the business name (i.e., field 316), first name (i.e., field 318), last name (i.e., field 328), street (i.e., field 320), apartment (i.e., field 330), city (i.e., field 322), state (i.e., field 334), zip code (i.e., field 332), telephone number (i.e., field 324), mobile telephone number (i.e., field 336), fax number (i.e., field 326) and email address (i.e., field 338). If the entered customer ID does not exist, an error message can be displayed. The user can then click a “Lookup” button to look up the customer, and then select an existing customer ID or create a new customer account. All Ticket fields are open for input (white) except the following display-only fields (grayed-out): Ticket Last Update Date and Ticket last update user ID. For an Existing Ticket, the customer ID field can be grayed out. All other customer related fields can be white and are editable. All changes made when saved can update the Customer record.

If the System Parameter for Track Customer Account is set to ‘No’ then a customer lookup button or an add customer button may not be opened for a new ticket. The customer ID field can be hidden and a customer look up can be allowed. All other customer related fields, if white, are editable. All changes made when saved will create the customer record with the next system generated customer ID, including information such as the business name, first name, last name, street, apartment or suite, city, state, zip code, telephone number, mobile telephone number, fax number and/or email address. For an existing ticket, the customer ID field can be hidden. All other customer related fields are generally white and are editable. All changes made when saved will update the Customer record.

The Ticket Event Section 305 includes ticket information, such that the ticket event information can generally be displayed with a row for each ticket event. The ticket events can be sorted in a descending order of Event Create Date illustrating the newest event first. The first row (newest Event) can be automatically selected upon entering this window. The following Ticket Event fields can be displayed on the screen: Create Date/Time 340, Description 341 (e.g., Event Type, Reason Name), Technician User ID 343, and Create ID345. All Ticket Event fields are grayed-out. Additionally a Ticket Comment Section 307 can be provided in which all comments for the ticket are displayed with the newest comment first. When a particular event is selected, the comment window should automatically scroll to the newest comment associated with that particular event. Comments can be added by selecting the Add Comment button 346. Thus, the ticket number can be entered at field 302, while a priority number can be entered at field 304. A Meet Date (i.e., appointment date) can be entered at field 306 and a Meet Time at field 308. A range can be entered at field 310.

A variety of menu options are available from the Ticket Detail Window (i.e., window 300). Such options include File, Edit, Event, Window and Help as indicated respectively at menu options 346, 348, 350, 352 and 354. The File 346 option includes New, Lookup Ticket, Save, Close, Print, and Copy options. The New option permits a blank Ticket Detail Window to be opened in add mode. Lookup permits a user to look up a ticket. The Save option permits a user to save a ticket and event and/or add comments to the database. The Close option closed this window. The Print option can permit a user to print ticket information for the current ticket. The Copy option can allow users to copy data from the current ticket to a new ticket, including customer ID, business name, first name, last name, etc. The Edit 348 option, on the other hand can enable a user to Cut, Copy and Paste. Cut enables a user to cut selected text to a clipboard application. The Copy feature of the Edit option enables a user to copy the selected text-to the clipboard application, and Paste enables a user to past clipboard content at the location of a cursor. The View 350 option can allow a user to select viewing options for Window 300.

The Event 351 menu can allow a dispatcher event to be added by opening an add event window. The Event option can also permit a technician event to be opened. An event window can also be added utilizing the Event option. Comments can be added and customer data added. Additionally, customer information can be organized in lists, added, and searched. The Window 352 menu can provide one menu option for each window that is open. As indicated previously, the Help 354menu can provide context-sensitive help application information. Event information can be entered at input field 340. Events are added via Add Event 342 button.

Events in the Ticket Detail Window can be handled by clicking on an unselected Event row highlights and selects that row. Any previously selected row is un-highlighted and deselected. The Comment Block 307 will scroll to the newest comments associated with the selected event. Again, comments can be added via Add Comment button 346. Double clicking an existing ticket event will open the Edit Ticket Event Dialog if the System Parameter allows this. Right button clicking can bring up the following popup menu. If the right button click is on a row, that particular row can be selected a dispatcher event added. Ticket events can also be edited utilizing an Edit Ticket Event Dialog if the cursor is placed on an event row. A technician can also be added but may be grayed out as discussed above. The following Ticket fields can be required on an addition operation, and may not be blanked out on an update: Customer ID (if track customer account number is ‘Yes’), Business Name or First Name or Last Name, Street Address and Phone Number. An Event with Event Type New can be created when the Ticket Information is saved. The User can add a comment by typing in the Comment Box or click the Add Comment button and select from a list of canned comments and edit it if necessary. Clicking on the Add Customer button will navigate to the Add Customer Window. Pressing the Escape key closes the window

A number of rules can be provided for permitting text messages to be utilized in association with the MDI. When the user closes the window without saving, a confirm prompt is displayed ‘Save Changes?’ with button Yes, No and Cancel and a ‘Send Text Message to Technician’ check box. The following rules can apply:

1. If the Event Type is ‘Assigned’—then the check box is defaulted based on the SMS assigned system parameter. The user can override it.

2. If an update to the ticket has been made and current status is Assigned, Acknowledged, Drive, Arrive, or Incomplete, then the check box is defaulted based on the ‘Send SMS on update’ system parameter. The user can override it.

3. If Cancel and Yanked is being performed in the same save the check box is defaulted based on the ‘Send SMS on update’ system parameter and the user can override it. If the box is checked send the update to the technician.

4. If a reassign and assign is being performed in one save the check box is defaulted based on the ‘Send SMS on update’ system parameter and the user can override it. If the box is checked send the reassign text message to the old technician and the assigned text message to the new technician.

If the user clicks “Yes” to save and the check box is checked then the system will send a Message to the technician. If the user saves with File Save menu option, CTRL-S, or the Tool Bar, use the appropriate rules above to determine if the SMS message should be sent and process accordingly. Similarly, The text message to the technician for the assigned event can include a message title, ticket number, due date, customer name, street, city, zip code, etc. The text message can also include the words “Message Body” followed by the actual text message. All Dispatcher Comments that have not been previously sent in an Alert Message sorted newest first. Similar information can be provided in the text message to the technician for a ticket update, including ticket number, due date, event type (most recent), customer name, street, city, zip code, and so forth.

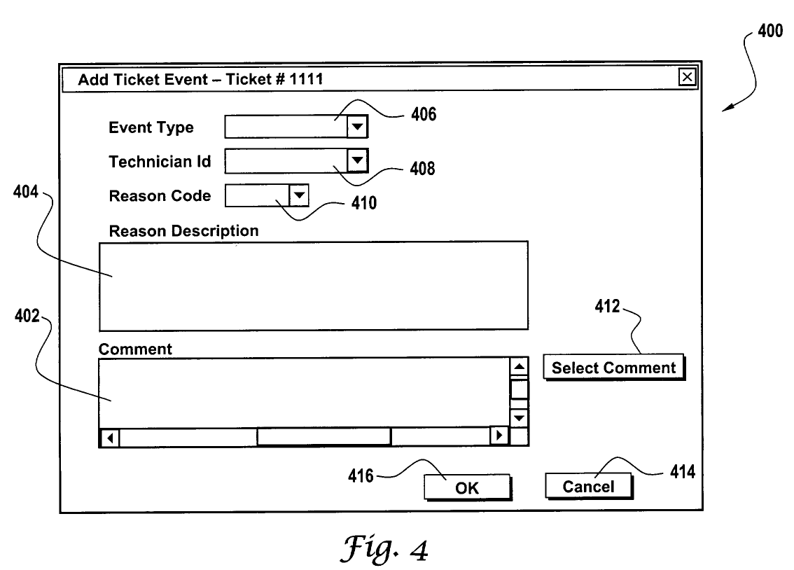

FIG. 4 depicts an add ticket event window 400, which can be implemented in accordance with a preferred embodiment of the present invention. Window 400 can permit a dispatcher to add a new event to an existing ticket. The window title can be “Add Ticket Event—Ticket #”. The following fields can be displayed with respect to window 400: Event Type 406 (Drop down list), User ID 408 or the name of Technician (Drop down list), Reason Code 410 or Name (Drop down), and Comment or Description 402. A Reason Description can be optional.

The Event Type 406 can default to the value in the ‘Default Next Event Type’ column below. Other allowable event types in the drop down list are also shown. Table 1 below illustrates example default and allowable event types based on the current ticket event type.

TABLE 1

| Current Ticket Event | | Other Allowable Next |
|---|---|---|
| Type | Default Next Event Type | Events Types |
| New | Dispatch Ready³ | Cancel |
| | Assign | Cancel |
| Dispatch Ready³ | Assign | Cancel |
| Assign | Reassign² | Cancel¹ |
| Acknowledged | Reassign² | Cancel¹ |
| Drive | Cancel¹ | Reassign² |
| Arrive | Cancel¹ | Reassign² |
| Incomplete | Reassign² | Cancel¹ |
| Complete | Close | Cancel |
| Reassign | Assign | Cancel |

¹If the Cancel Event is selected as the next event and the current event is Assign, Acknowledged, Drive, Arrived or Incomplete the system automatically creates a Yanked event with the old technician's id and a Cancel event with no technician id
²If the Reassign Event is selected as the next event, the system automatically creates a Reassign Event with the old Technician's Id and an Assigned Event with the new Technician's Id.
³These rules apply only if the System Parameter to use Dispatch Ready event type is set to ‘Yes’

The Technician ID 408 field is generally blank and editable if the selected event type is Assign or Reassign. The technician ID 408 field may be grayed out at all other times. The technician ID 408 field is generally blank for the following Dispatcher Event Types: New, Dispatch Ready, Cancel, and Closed. The Reason Code 410 is required if the System Parameter so indicates. Otherwise it is not allowed and grayed out. The comments description 402 is either entered by the user or is selected from a canned list by clicking on the Select Comment button 412. Comments entry is associated with the Select Comment button 414.

Events in the Add Ticket Event Window 400 can be handled by clicking the OK button 416, which validates the entered data and creates the new event(s) with entered data, closes the window. Events in this window can also be handled utilizing the Create Date Time for the new events is the System Date/Time. If a reason code has been selected then it is associated with the new event. Double clicking the technician ID field opens the user summary window. Clicking the Cancel button 414 closes the window.

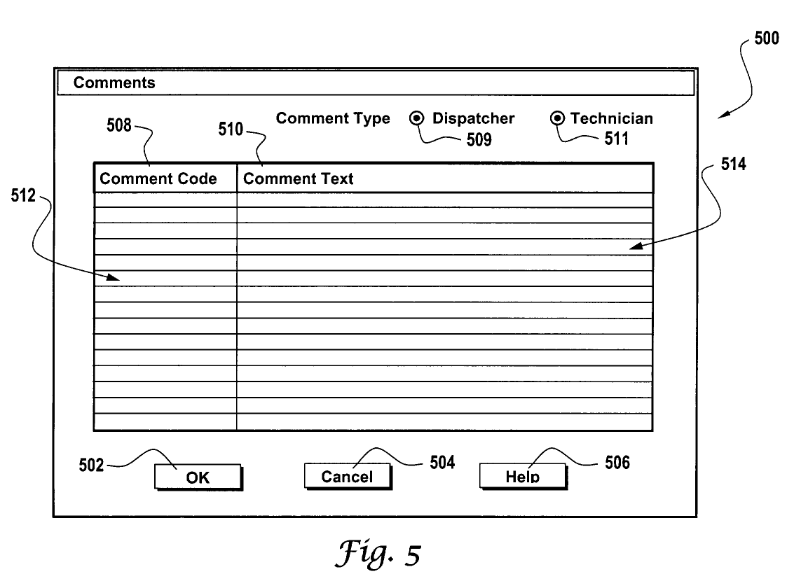

FIG. 5 illustrates a standard comments window 500, which can be implemented in accordance with a preferred embodiment of the present invention. Window 500 includes radio buttons 509 and 511, which respectively are associated with either dispatcher or technician data. Comments are added via a comment section 512. Appropriate OK, Cancel and Help buttons 502, 504, and 506 are also respectively provided via window 500. Window 500 essentially can be configured as a dialog box, whose purpose is to allow a dispatcher to view a list of all Comment Codes and a Comment Description. The display has a number of characteristics, such as each row representing a comment. Two columns can be provided, including a Comment Code column 508 and a Comment Text column 510. Buttons 509 and 511 respectively activate dispatcher or technician modes. The bottom half of window 500 can display a detailed description of a highlighted row. The comments are generally sorted by comment code. The User Type can default to Dispatcher unless the window was entered from the Add Technician Event dialog.

Events in the Standard Comments Dialog can be handled by clicking on an unselected row highlights and selects that row. Any previously selected row is unhighlighted and deselected. Clicking the OK button 502 with a row selected (or double clicking on a row), closes the Standard Comments Dialog, and returns to the Add Event Window with the Comment text. Clicking the Cancel button 504 closes the Standard Comments Dialog.

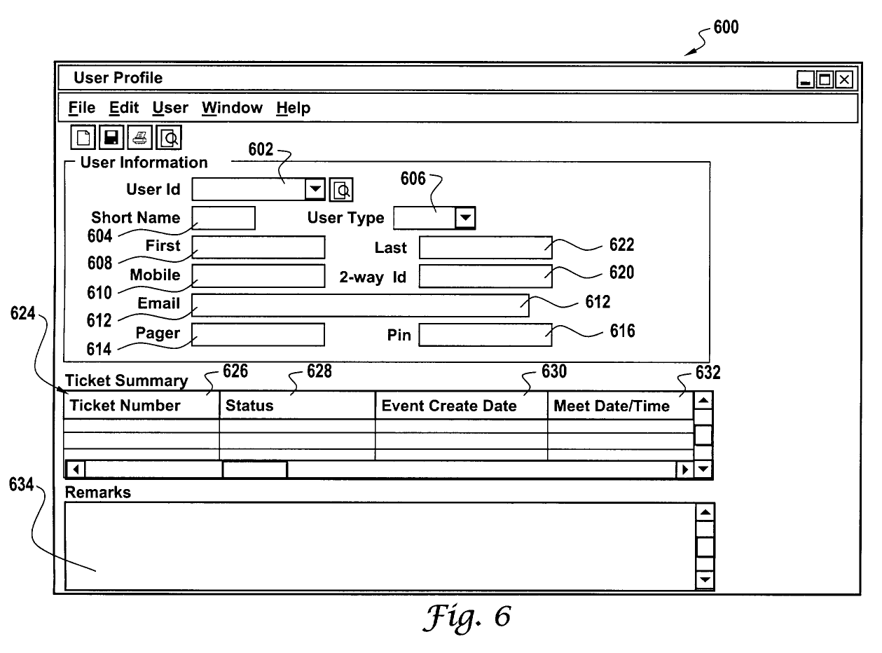

FIG. 6 depicts a user profile window 600, which can be implemented in accordance with a preferred embodiment of the present invention. Window 600 can include a User ID field 602 for selecting or entering a User ID. A Short Name field 604 can also be provided for entering an abbreviation or short name associated with the User ID entered at User ID field 602. A User Type field 606 is also provided for selecting or entering User Type data. Additionally, the user's first name, last name, mobile telephone number, 2-way ID, email address, pager number and PIN number can be respectively entered at fields 608, 622, 610, 620, 612, 614, and 616. A Ticket Summary section 624 can also be provided in which ticket related data can be entered, including a Ticket Number column 626, a Status column 622, an Event Create Date column 630, and a Meet Date/Time column 632. Remarks can be entered into a Remarks Field 634. Window 600 can permit a dispatcher user to read and update user profiles provided the dispatcher user has the requisite administrative authority. Multiple instances of this window may be open at a time. Employee fields are updateable (white) except User ID, last update time, and last update user ID, which are display-only (grayed out). The User ID field 602 can be open for input when in add mode. If the user type being displayed is a dispatch technician, the user can be allowed to display a list of open dispatches for that dispatch technician.

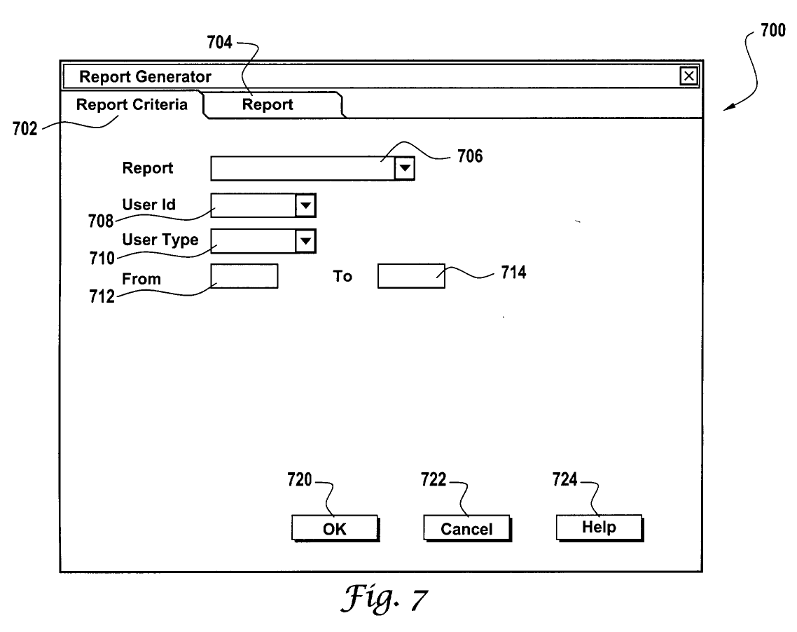

FIG. 7 illustrates a report generator window 700, which can be implemented in accordance with a preferred embodiment of the present invention. Window 700 can include two graphically displayed tabs, a Report Criteria tab 702 and a Report tab 704. Report Criteria tab 702 when activated can include a variety of specialized fields for entering data. A Report field 706 can permit a user to select or enter a particular report. The Report field 706 can provide a drop down list of reports from which users can select. Radio buttons 716 and 718 can permit a user to choose either a summary or detail report, respectively. The Summary and Detail options can determine if counts or list of tickets are being requested. A User ID field 708 can also be provided, which permit a user to select or enter a particular User ID. The User ID 708 field can enable the selection of an individual employee. If ‘ALL’ is selected the information for all relevant employees can be reported. A User Type field 710 can also be provided, which permits a user to select or enter a particular User Type. The User Type required if ‘ALL’ is selected in the User id field. Otherwise it can be default based on the User Id entered. Additionally, “Date From” and “Date To” data can be entered via fields 712 and 714, respectively. Window 700 allows a user to determine the criteria against which the report will be created.

Table 2 below provides an example listing of typical canned reports and the validation rules for the fields associated with window 700.

TABLE 2
List of Reports and Validation Rules

| Report | User Id | User Type |
|---|---|---|
| Summary/Detail of | Only User Id of User Type = | Defaults to User |
| tickets dispatched | Dispatcher | Type of |
| by a dispatcher | can be entered or | Dispatcher |
| | ‘All’ | |
| Summary/Detail of | Only User Id of User Type = | Defaults to User |
| tickets worked by a | Technician | Type of |
| technician | can be entered or | Technician |
| | ‘All’ | |
| Summary/Detail of | Only User Id of User Type = | Defaults to User |
| Incomplete or | Technician | Type of |
| Reassign | can be entered or | Technician |
| | ‘All’ | |
| dispatches by | | |
| technician and | | |
| reason code | | |
| Summary/Detail of | Only User Id of User Type = | Defaults to User |
| Cancelled or Closed | Dispatcher | Type of |
| tickets by dispatcher | can be entered or | Dispatcher |
| and reason code | ‘All’ | |
| Summary/Detail of | Only User Id of User Type = | Defaults to User |
| Open tickets for a | Technician | Type of |
| technician as of a | can be entered or | Technician |
| certain date | ‘All’ | |

No menu items need to be associated with this window. Three command buttons are provided from which the user must choose, including an OK button 720, a Cancel button 722 and a Help button 724. The OK button 720 insures that required columns and data relationships are validated. If valid, the report is generated against the chosen criteria. Otherwise, a message is displayed indicating what is invalid and how to correct it. The Cancel button 720 permits a user to exit the report process, and does not allow the report to be generated. The Help button 724 launches context-sensitive help.

Events for the Report Criteria window can be based on several required fields, including the Report field 706, the Date From field 712 and the Date To field 714. The Date To field 714 must reflect a point in time after that shown in the Date From field 712. If not, the user can be presented with a message to that effect and can be given the opportunity to correct the data.

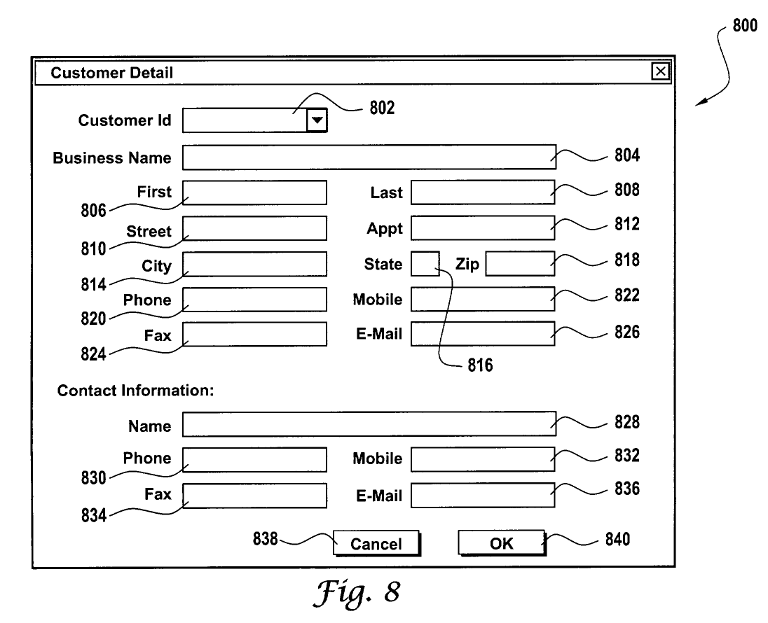

FIG. 8 depicts a customer detail window 800, which can be implemented in accordance with a preferred embodiment of the present invention. Window 800 can include a Customer ID field 802, a Business Name field 804 and fields thereof providing additional detailed information about the customer. For example, the first name of the customer can be entered via field 806. The last name of the customer can be provided utilizing field 808. The customer street address can be entered via field 810, while the customer apartment number can be provided via field 812. A user can also enter the customer city, state and zip code respectively through fields 814, 816 and 818. Additionally, the customer phone number can be entered via field 820. The customer mobile telephone number can be entered utilizing field 822. Similarly the fax number and email address can be entered respectively via fields 824 and 826.

Contact information can also be provided via additional fields. A contact name can be entered via field 828, while a contacts phone number can be entered utilizing field 830. A mobile telephone number can be entered utilizing field 832 and fax and email information entered respectively via fields 834 and 836. Window 800 thus can permit a dispatcher user to create, read, and update a Customer. Information and Customer ID can be grayed out if an existing customer. If a new customer is being added and If the System Parameter ‘Track Customer Account is set to ‘No’ then the Customer ID field 802 can be pre-populated as soon as this window opens up and cannot be edited. Otherwise the user enters the Customer ID data. If the Customer ID data entered already exists an error message can be displayed. If an existing customer is being view/edited then the Customer ID field 802 can be pre-populated as soon as window 800 opens up and cannot be edited. A Cancel button 838 and an OK button 840 are also provided to respectively permit a user to exit window 800 or validate data thereof.

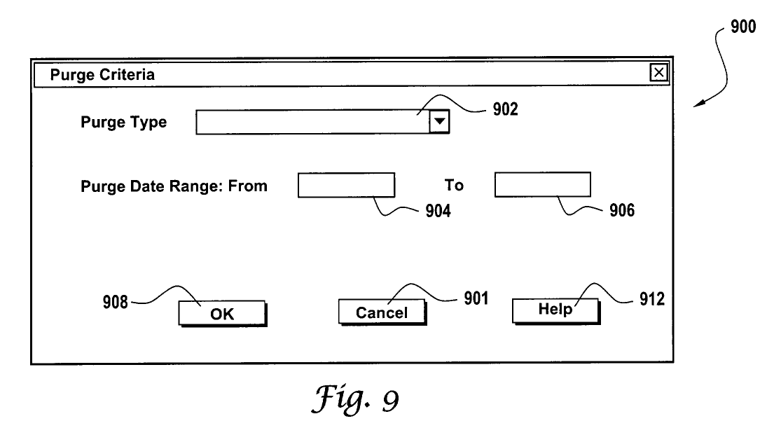

FIG. 9 illustrates a purge criteria window 900, which can be implemented in accordance with a preferred embodiment of the present invention. The Purge Criteria window 900 can enable a user to capture the date range for executing the purge. A Purge Type field 902 can provide a Drop Down list from which a user can select. Two types of purge include a Ticket Purge and a Customer Purge. The Purge Type field 902 can be grayed out if the business does not track customer accounts. The Purge Date Range From and Date To fields, 904 and 906 respectively, allow the entry of the date/time range for purging data. Date From defaults to the previous To Date. Date To also defaults to the same. The Date To field 906 must reflect a point in time after that shown in the Date From field. If not, the user can be presented with a message to that effect and will be given the opportunity to correct the data.

Menu items do not need to be associated with this window. Three command buttons, however, are provided from which the user must choose, including an OK button 908, a Cancel button 910, and a Help button 912. If the OK button 908 is pressed, the purge is executed, if valid. Otherwise, a message can be displayed indicating what is invalid and how to correct it. The cancel button 910 permits a user to exits the purge process without purging. The Help button 912 launches context-sensitive help. When the purge is executed the following occurs: If the Purge Type=Customer, the customers, tickets, ticket events and comments for tickets that meet the date criteria are archived to a flat file database. The same records can be deleted from the active database If the Purge Type=Tickets, the tickets, ticket events and comments for tickets that meet the date criteria are archived to a flat file database. The same records can be deleted from the active database.

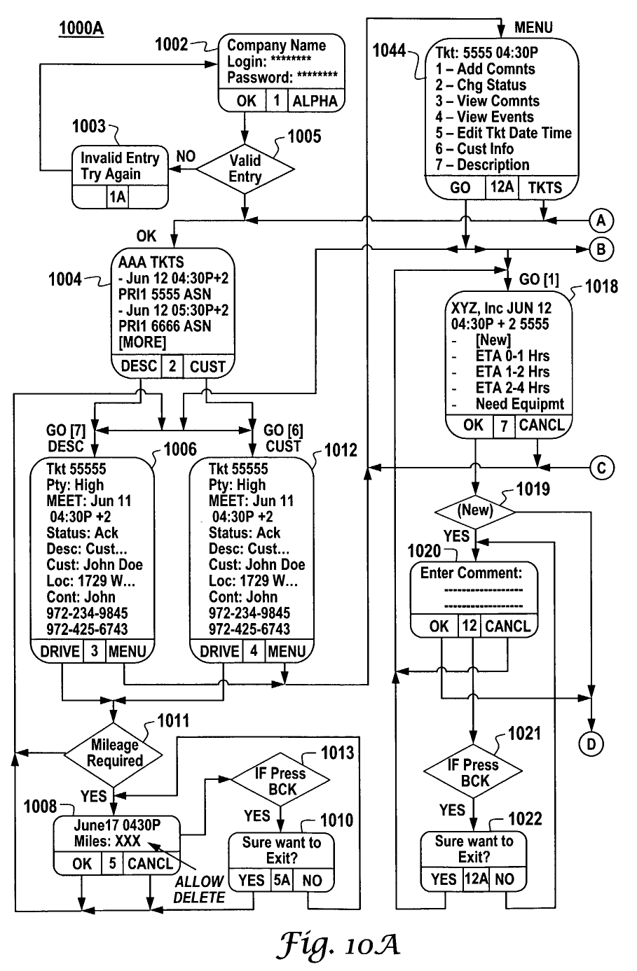

FIGS. 10A and 10B depict a high-level flow chart of operations illustrating logical operational steps for a mobile device interface (MDI), which can be implemented in accordance with a preferred embodiment of the present invention. The first portion of the flow chart is labeled flow chart 1000A in FIG. 10A, while the continuation of flow chart 1000A is labeled 1000B in FIG. 10B. FIGS. 10A and 10B thus together illustrate a single diagram, represented continuously beginning with flow cart 1000A and ending with flow chart 1000B. Note that continuation blocks A, B, C and D are indicated in both FIGS. 10A and 10B to represent logical process continuation or connectors between flow charts 1000A and 1000B. The diagram illustrated in FIGS. 10A and 10B generally indicates one potential screen flow for an MDI. Such a screen flow can be organized according to particular “cards,” each of which is discussed in greater detail below. Those skilled in the art can appreciate that the cards illustrated in flow charts 1000A and 1000B of FIGS. 10A and 10B represent merely some of the many possible types of cards that can be implemented in accordance with the invention described herein. Only a few of the many types of cards that are available are described herein and are presented for general edification and illustrative purposes only and to give the reader a taste of one potential embodiment of the present invention.

As indicated at block 1002 of FIG. 10A, a card for validating a user ID and password, or for example biometric authentication information is presented for the user via an MDI. If the user types an invalid password and/or a number, the user is prompted to “try again” as indicated at block 1003 and decision block 1005. Assuming that the user is validated successfully, then a card possessing ticket (i.e., a work order) information can be displayed for the user, as illustrated at block 1004. The user can select an interface based on either the term DESC or CUST, which is displayed for the user as indicated at block 1004. If the user chooses DESC, then the user is presented with the card illustrated at block 1006, which functions as ticket description card presenting information associated with the current work order (i.e., ticket). If the users selects the card displayed as indicated at block 1006, then the user is presented with the card depicted at block 1012.

Thus, as depicted at block 1006, information can be displayed for the user indicative of the priority of the ticket at issue. Mileage information may or may not be required to be entered by the technician user depending on a system parameter. As indicated at decision block 1011, an operation verifying mileage information requirements can be processed following the operation indicated at block 1006. If mileage information is required, then as illustrated at block 1008, a user may enter such information. Thereafter, as depicted at block 1010, a user is prompted to exit. If the user chooses not to exit, then the user can be returned to the card displayed at block 1008. If the user chooses to exit, as illustrated at block 1010, the user can be presented with the card illustrated at block 1006 or the card illustrated at block 1012.

If the user has already begun the work order, the user can transmit additional text information to the dispatcher indicating the status of the work order or ticket. For example, as illustrated at block 1018, the user can transmit information back to the dispatcher indicating that additional equipment is required and/or a particular estimated time of arrival (ETA). Following processing of the operation illustrated at block 1018, a decision is made as indicated at decision block 1019 whether or not to enter additional information (e.g., comments) for transmission to the dispatcher or return to the operation depicted at block 1018. If additional comments are required, then as indicated at block 1020, the user can enter additional comments, which can then be transmitted to the dispatcher. Such comments can be added and/or deleted, depending on the desires of the technician. Following processing of the operation illustrated at block 1020, the user can continue adding comments or exit, as indicated via decision block 1021 and block 1022. Ad depicted at block 1022, the user can be prompted to exit. If the user chooses not to exit, then the user can be returned to the card displayed at block 1020. If the user chooses to exit, as illustrated at block 1022, the user can be presented with the card illustrated at block 1018.

The user can also be presented with a card that permits the user to send data back to the dispatcher indicating whether the work order should be reassigned, or has been completed or is incomplete, as indicated at block 1024. The words Reassign, Incomplete, and Complete can be displayed for the user, as indicated at block 1024. The user simply chooses which of the aforementioned options should be selected. If a particular reason is required to justify the user selection, then as indicated next at decision block 1025 and block 1026, the user can choose a particular reason or justification for requesting a reassignment or incomplete/complete designation. For example, as depicted at block 1026, the user can indicate that he or she is currently on break or that tools are not available and so forth. The card illustrated at block 1026 generally displays a list of canned reason codes from which a user can select based on the selected event type. A card can also be activated by the user, which provides an alert, which can be transmitted to the dispatcher, as indicated at block 1046. Verification of a dispatcher alert can be provided, as illustrated at decision block 1023.

As illustrated at block 1028, the user can provide the dispatcher with additional information, such as information that the “first part was defective, waiting on more” and so forth. Alternatively, as illustrated at block 1034, a user can obtain information regarding the status of all ticket events associated with a ticket and in a particular order (e.g., descending date/time). Ticket events can be updated and acknowledged as indicated at block 1030. Following processing of the operation illustrated at block 1030, a test is performed to determine whether or not the user is required to transmit mileage information to the dispatcher. If the user is not required to transmit mileage information, then the user can be prompted with the card illustrated at block 1034. If the user is required to input mileage information for transmission to the dispatcher, then as indicated at block 1036 the user is permitted to edit the mileage information, which can be transmitted back to the dispatcher. Thus, the dispatcher can receive updated mileage information. The updated mileage information can be validated, as indicated at decision block 1037. The user may also exit the card indicated at block 1036, as illustrated thereafter via decision block 1039 and block 1038. Note that cards 1010, 1022, 1038, and 1042 are generally analogous to one another.

The user can additionally edit the meet date/time of a scheduled work order, as illustrated at block 1040 and thereafter exit, as indicated at decision block 1041 and block 1042. Following an “exit” card, such as, for example, the “exit” card displayed at block 1022, a user can be prompted with a menu, as indicated at block 1044. This menu permits a user to add comments, change the status of a ticket or ticket event, view comments, view events, and edit ticket information, customer information and descriptions thereof.

In general, a number of characteristics are valid throughout the technician application components, some of which are illustrated in FIGS. 10A and 10B. For example, an “open ticket” is one, which has a most recent ticket event status equivalent to New, Dispatch Ready, Assigned, Acknowledged, Drive, Reassign, Arrive, Yanked, Complete or Incomplete. A “finished ticket” is one, which has Ticket Event with status equal to Cancelled or Closed. Updates performed by a dispatch technician user, such as the status or adding comments can be communicated to the central database. If a user exits any card without saving changes, that particular can be prompted with an exit confirmation.

The following two fields can be updated whenever a dispatch technician updates either the Ticket or one of the Ticket Events: ticket last update date/time and ticket last update user ID. The ticket last update date/time is the current system time at which a user saves. The ticket last update User ID is associated with the currently logged-on user. Whenever the Ticket Meet Date and Time are required to be displayed on the mobile device, if the Meet Date is equal to the current date, only the Meet Time is displayed. Additionally, all cards can conform closely to the SprintPCS® Style Guide for Wireless Applications. Of course, the SprintPCS® Style Guide for Wireless Applications represents only one type of wireless interface application that can be utilized to implement an embodiment of the present invention. The SprintPCS® Style Guide for Wireless Applications should not be considered a limiting feature of the present invention, but instead one of many possible techniques that may be utilized to implement varied embodiments of the present invention.

Block 1002 illustrates a card that can be utilized to capture a user ID and password of a technician and validates this data in real time against a central database to prevent unauthorized system access. This card can have the general properties as illustrated in Table 3 below:

TABLE 3

| Card Feature | Description | Remarks |
|---|---|---|
| Type | Entry | |
| Header/Card Title | Company Name | System parameter |
| Text Behavior | Wrap | |
| Softkeys/Hotkeys: | | |
| Primary Softkey | ‘OK’ | |
| Secondary Softkey | ‘ALPHA/NUM’ | |
| Link | None | |
| Back Key | No label | Exits the application |
| Home Key | No label | Exits the application |
| Scroll Up/Down | No label | Moves the cursor between the |
| | | entry fields |
| Page Up/Down | No label | No Action |
| Menu Key | No label | Exits the application |
| Scroll Right/Left | No label | Moves the cursor one character |
| | | at a time |

In general, the user ID and password can be numeric in order to simplify typing for the user. The user ID and password fields are also generally blank on entry. A cursor can be positioned on the first character of the User ID on entry. Such a cursor can automatically jump to a password field at the end of a permissible number of numbers/characters associated with the user ID field.

Selecting an OK button can validate the user ID and password entered by the user and an “Error” card may be displayed if it fails validation. If validation is achieved, “Open Tickets List” card is opened and displayed for the user as indicated at block 1004. Selecting an ALPHA button on the user device (e.g., a mobile wireless PDA and/or cellular telephone) toggles the entry mode between alphabets and numbers. The card illustrated at block 1004 generally can list all the tickets that have been assigned to the logged on technician with statuses, including Assigned, Acknowledged, Drive, Arrive and/or Incomplete. The card illustrated at block 1004 can possess the properties illustrated in Table 4:

TABLE 4

| Card Feature | Description | Remarks |
|---|---|---|
| Type | Select List | |
| Header/Card Title | ‘AAA Tickets’ | AAA is the short name of the User |
| Text Behavior | Flicker | |
| Softkeys/Hotkeys: | | |
| Primary Softkey | ‘DESC’ | Abbreviation for Ticket |
| | | Description |
| Secondary Softkey | ‘CUST’ | Abbreviation for |
| | | Customer Information |
| Link | None | |
| Back Key | No label | Logs off the current user |
| | | and Returns to Logon |
| | | card |
| Home Key | No label | Exits the application |
| Scroll Up/Down | No label | Moves the cursor one ticket |
| | | at a time |
| Page Up/Down | No label | Scrolls one screen of |
| | | data at a time. This is |
| | | device specific and may |
| | | not be available on some |
| | | phones |
| Menu Key | No label | Goes to the Ticket Menu |
| | | for the selected row |
| Scroll Right/Left | No label | Same as up down |

One row on the card represents one ticket. Particular information can be listed for each ticket. For example, Due Date/Time and Range represents the start of the time interval when the customer is expecting the technician to be at the customer site. The range is the total time interval during which the customer is expecting the technician to be at the customer site. If the Meet Date/Time is for an appointed time then the range will be blank and will not be displayed on the screen. Ticket Priority represents the level of priority assigned by the dispatcher to the ticket. This field will be always prefixed with ‘Pri’ (e.g., Pri1, PriA, etc.). If the priority field is blank then it is not displayed. Ticket Status represents the status of the ticket determined by the event type of the most recent event. Reason Name represents the short description of the reason associated with some statuses. If no reason is available this field will be blank. Ticket Number represents a system generated unique number to identify a ticket. The tickets can be sorted according to a particular methodology. For example, all tickets with Event Type=‘Assigned’ can be on the top sorted by Priority plus Due Date and Time. All remaining tickets can be next, sorted by Priority plus Due Date and Time irrespective of Event Type For both of the above sorts a blank priority can be sorted so it appears after a non-blank priority.

The card illustrated at block 1004 can support a number of operations, such as selecting the ‘DESC’ softkey to navigate to a Ticket Detail—Ticket Description card, or selecting the ‘CUST’ softkey to navigate to a Ticket Detail—Customer Information card. Pressing the ‘Up/Down’ Arrows can scroll one ticket at a time. Pressing the ‘Page Up/Page’ Down Arrows can scroll one screen at a time. Additionally pressing the ‘HOME’ key can exit the application. Pressing the ‘MENU’ key can permit a user navigate to the Ticket Menu card for the selected row. The ‘BACK’ key can initiate a log off operation and return to the logon screen, which is illustrated at block 1002.

The Ticket Detail—Ticket Description card is depicted at block 1006. This card can display the ticket in formation and customer information for a particular ticket. The card illustrated at block 1006 can possess the properties, shown in Table 5:

TABLE 5

| Card Feature | Description | Remarks |
|---|---|---|
| Type | Display | |
| Header/Card Title | None | No blank title line if |
| | | possible |
| Text Behavior | Wrap | |
| Softkeys/Hotkeys: | | |
| Primary Softkey | ‘DRV/ARV/CMP’ | Abbreviation for Ticket |
| | | Statuses |
| | | DRV - Drive |
| | | ARR - Arrive |
| | | CMP - Complete |
| | | The label for the softkey |
| | | is dynamically set based |
| | | on the rules in Table 6 |
| | | below. |
| Secondary Softkey | ‘CUST’ | Abbreviation for |
| | | Customer Information |
| Link | The Primary softkey | Customer Phone |
| | label will change | number(s) |
| | to ‘CALL’ when the link | |
| | is selected | |
| Back Key | No label | Navigate back to the |
| | | Open Ticket List card |
| Home Key | No label | Exits the application |
| Scroll Up/Down | No label | Moves the cursor one |
| | | line at a time |
| Page Up/Down | No label | Scrolls one screen of |
| | | data at a time. This is |
| | | device specific and may |
| | | not be available on some |
| | | phones |
| Menu Key | No label | Goes to the Ticket Menu |
| | | for the selected row |
| Scroll Right/Left | No label | Moves the cursor one |
| | | character at a time |

In general, a card can represent a single ticket. Particular information can be displayed for each ticket. For example a Ticket Number represents a system generated unique number to identify a ticket. Priority identifies the level of priority assigned by the dispatcher to the ticket. If the ticket has been assigned a priority then it is displayed with a ‘Pri’ prefix. Example: Pri1, PriA, etc. If the priority field is blank then it is not displayed. Meet Date/Time and Range is the start of the time interval when the customer is expecting the technician to be at the customer site. The Range is the total time interval during which the customer is expecting the technician to be at the customer site. If the Meet date/time is for a specific time then the range will be blank and will not be displayed on the screen. If the Meet Date is equal to the Current Date, then only the Meet Time is displayed. Status Date and Time is the status of the ticket determined by the event type of the most recent event and the date/time when that event was created. If the Status Date is equal to the Current Date, then only the Status Time is displayed. Description is the most recent comment added by the dispatcher. The business name of the customer along with the customer last name and/or first can also be displayed for the user if available. A label may be completely dropped from the card, however, if neither the last name nor first name is provided. Additionally, the location of the business can be displayed for the user, including the street address, city, zip code and so forth. If any of these fields are blank, they can be ignored. If all of the fields are blank, the location label can be dropped entirely from the card. Phone numbers associated with the customer can also be displayed for the user technician. The Primary Softkey label can default to the abbreviation for the Softkey Function based on Table 6 below:

TABLE 6
Rules for Ticket Status Changes via the Softkey

| Current Event Type | Softkey Function |
|---|---|
| Acknowledged | Drive¹ |
| | Arrive² |
| Drive¹ | Arrive |
| Arrive | Complete |
| Incomplete | Drive¹ |
| | Arrive² |

¹This status change is used if the System Parameter to use the Drive Status is set to ‘Yes’.
²This status change is used if the System Parameter to use the Drive Status is set to ‘No’.

The card can support a number of events. For example, as soon as a ticket with an assigned status is accessed via this card, it automatically changes the status to Acknowledged. Selecting the Primary Softkey can update the ticket to the appropriate status (i.e., create the appropriate Ticket Event and Type) based on the rules in Table 6 above and navigate to a Mileage Entry card if the previous Status was Drive (DRV) and the new Status is Arrive (ARV) and the system parameter to Track Mileage is set to Yes. An example of a mileage entry card is depicted at blocks 1008. Additionally, the Ticket Detail—Ticket Description card can be redisplayed in all other cases. The softkey label can be defaulted appropriately. Selecting the ‘MENU softkey can navigate to the Ticket Menu card. Pressing the ‘Up/Down’ Arrows can scroll one row at a time. Additionally, pressing the ‘Page Up/Page Down’ Arrows can scroll one screen at a time if the device supports it. Pressing the ‘HOME’ key can exit the application. Also, pressing the ‘MENU’ key can navigate to the Ticket Menu card. Pressing the ‘BACK’ key can go back to the Open Ticket List card. Scrolling to the Contact Phone Number Link can change the Softkey label to CALL. Selecting a CALL button can initiate a voice call by dialing the number. On the completion of the call it returns to the same position.

The Ticket Detail—Customer Information card displays customer and ticket information for a particular ticket. Such a card can have properties as indicated in Table 7:

TABLE 7

| Card Feature | Description | Remarks |
|---|---|---|
| Type | Display | |
| Header/Card Title | None | No blank title line if |
| | | possible |
| Text Behavior | Wrap | |
| Softkeys/Hotkeys: | | |
| Primary Softkey | ‘DRV/ARV/CMP’ | Abbreviation for Ticket |
| | | Statuses |
| | | DRV - Drive |
| | | ARR - Arrive |
| | | CMP - Complete |
| | | The label for the softkey |
| | | is dynamically set based |
| | | on the rules in Table 4 |
| | | below. |
| Secondary Softkey | ‘CUST’ | Abbreviation for |
| | | Customer Information |
| Link | The Primary softkey | Customer Phone |
| | label will change | number(s) |
| | to ‘CALL’ when the link | |
| | is selected | |
| Back Key | No label | Navigate back to the |
| | | Open Ticket List card |
| Home Key | No label | Exits the application |
| Scroll Up/Down | No label | Moves the cursor one |
| | | line at a time |
| Page Up/Down | No label | Scrolls one screen of |
| | | data at a time. This is |
| | | device specific and may |
| | | not be available on some |
| | | phones |
| Menu Key | No label | Goes to the Ticket Menu |
| | | for the selected row |
| Scroll Right/Left | No label | Moves the cursor one |
| | | character at a time |

This card displays data pertaining to a single ticket. It is similar to the Ticket Detail—Ticket Description card except for the order of the information. The Customer Information is displayed before the ticket information. Particular information can be displayed for each ticket, such as the ticket number, the business name of the customer, last name/first name, location (i.e., address, zip, etc.), phone number, and priority level. For example, as indicated at block 1006 a “High” priority level is indicated for a particular ticket.

The card can support a number of events. Selecting the Primary Softkey will update the ticket to the appropriate status (i.e., create the appropriate Ticket Event and Type) based on the rules in Table 6 above, and navigate to a Mileage Entry card if the previous status was Drive (DRV) and the new status is Arrive (ARV) and the system parameter to Track Mileage is set to Yes. The Ticket Detail—Customer Information card can be redisplayed in all other cases. The softkey label will be defaulted appropriately. Selecting the ‘MENU softkey can permit a user navigate to the Ticket Menu card. Additionally, pressing the ‘Up/Down’ Arrows can scroll one row at a time. Also, pressing the ‘Page Up/Page’ Down Arrows can scroll one screen at a time if the device supports it. Pressing the ‘HOME’ key can permit a user to exit the application. Pressing the ‘MENU’ key can allow a user to navigate to the Ticket Menu card. Alternatively, pressing the ‘BACK’ key will go back to the Open Ticket List card. Scrolling to the Contact Phone Number Link can change the Softkey label to ‘CALL’. Additionally, Selecting the CALL button can initiate a voice call by dialing the number. On the completion of the call it returns to the same position

The card depicted at block 1044 essentially displays a list of action choices that can be performed on a particular ticket. The card described at block 1024 can have properties as indicated in Table 8:

TABLE 8

| Card Feature | Description | Remarks |
|---|---|---|
| Type | Select List | |
| Header/Card Title | Based on System | |
| | Parameter comma- | |
| | separated concatenation | |
| | of | |
| | Customer Name | |
| | or First/Last Name | |
| | Meet Date/Time | |
| | and Range | |
| | Ticket Number | |
| Text Behavior | Flicker | |
| Softkeys/Hotkeys: | | |
| Primary Softkey | ‘GO’ | |
| Secondary Softkey | ‘TKTS’ | Abbreviation for Tickets |
| Link | None | |
| Back Key | No label | Navigate to the previous |
| | | screen if possible |
| Home Key | No label | Exits the application |
| Scroll Up/Down | No label | Moves the cursor one |
| | | ticket at a time |
| Page Up/Down | No label | Scrolls one screen of |
| | | data at a time. This is |
| | | device specific and may |
| | | not be available on some |
| | | phones |
| Menu Key | No label | Inactive if possible. |
| | | Otherwise navigate to |
| | | the Open Ticket List if |
| | | possible |
| Scroll Right/Left | No label | Moves the cursor one |
| | | character at a time |

The card illustrated at block 1024 represents options that a user can perform on a ticket, and can support a number of events. For example, selecting the ‘GO’ softkey with the Add Comments option highlighted can permit a user to navigate to the Add Comment card. Alternatively, selecting the ‘GO’ softkey with the Chg Status option highlighted can permit a user navigate to an Add Event card. Additionally, selecting the ‘GO’ softkey with the View Comments option highlighted permits a user to navigate to the View Comments card. Likewise, selecting the ‘GO’ softkey with the View Events option highlighted permits a user to navigate to the View Events card. Selecting the ‘GO’ softkey with the Edit Meet Time option highlighted can permit the user to navigate to the Edit Meet Time card (option is only displayed if the system parameter for technician updates to ticket is set to ‘Yes’). Selecting the ‘GO’ softkey with the Cust Info option highlighted can permit the user to navigate to the Ticket Detail—Customer Information card. Selecting the ‘GO’ softkey with the Description option highlighted can permit the user to navigate to the Ticket Detail—Ticket Information card. Pressing the ‘Up/Down’ Arrows can permit the user to scroll one row at a time. Similarly, pressing the ‘Page Up/Page’ Down Arrows can permit the user to scroll one screen at a time. Pressing the ‘HOME’ key can permit the user to exit the application. Also, pressing the ‘BACK’ key can permit the user to go back to the previous card.

The card illustrated at block 1018 displays a list of comments that can be selected to add to a ticket event. The card illustrated at block 1018 can possess properties as illustrated in Table 9:

TABLE 9

| Card Feature | Description | Remarks |
|---|---|---|
| Type | Select List | |
| Header/Card Title | Based on System | |
| | Parameter comma- | |
| | separated concatenation | |
| | of | |
| | Customer Name | |
| | or First/Last Name | |
| | Meet Date/Time | |
| | and Range | |
| | Ticket Number | |
| Text Behavior | Flicker | |
| Softkeys/Hotkeys: | | |
| Primary Softkey | ‘OK’ | |
| Secondary Softkey | ‘CANCL’ | |
| Link | None | |
| Back Key | No label | Navigate to the previous |
| | | screen |
| Home Key | No label | Exits the application |
| Scroll Up/Down | No label | Moves the cursor one |
| | | comment at a time |
| Page Up/Down | No label | Scrolls one screen of |
| | | data at a time. This is |
| | | device specific and may |
| | | not be available on some |
| | | phones |
| Menu Key | No label | Navigate to the Open |
| | | Ticket List if possible |
| Scroll Right/Left | No label | Moves the cursor one |
| | | character at a time |

The card lists comments that a user can select to add to a ticket event. The Comments are generally pre-defined in the system. The first option in the list is generally always NEW. The remaining comments are selected from the list of user-defined comments and sorted on order of comment sequence number. Only comments of Type=Technician are listed.

This card can support a number of events. Selecting the ‘OK’ softkey with the NEW option highlighted permits a user to navigate to the Comment Entry card where the user can type a comment instead of selecting from the canned list of comments. Selecting the ‘OK’ softkey with another row selected will select the comment and automatically set the Alert Dispatcher flag and navigate to the View Comments card if the system parameter for Auto alert dispatcher is Yes; and navigate to the Alert Dispatcher card if the system parameter for Auto alert Dispatcher is No. Note an example of the Alert Dispatcher card is depicted at block 1046. Pressing the ‘Up/Down’ Arrows can permit the user to scroll one row at a time. Pressing the ‘Page Up/Page’ Down Arrows can permit the user to scroll one screen at a time. Pressing the ‘HOME’ key can permit a user to exit the application. Pressing the ‘BACK’ key can permit the user to go back to the menu.

The operation illustrated at block 1030 can permit a user to edit the particular event related fields if the system parameter allows such edits and is set to ‘Yes’ and if the current user created the event. Events that can thus be edited include the create Date/Time of a ticket event, the miles if the event type is Drive, and the system flag to track mileage if set to Yes. Two cards that may be required for this update, including an Edit Event Date card and an Edit Miles card (i.e., if the Event Type of the Event being edited is Drive and the System flag to Track Mileage is set to Yes). Table 9 below describes properties that can be associated with a card as illustrated at block 1030. The Edit Event Date and the Edit Miles cards can have the following general properties:

TABLE 9

| Card Feature | Description | Remarks |
|---|---|---|
| Type | Entry | |
| Header/Card Title | None | |
| Text Behavior | Wrap | |
| Softkeys/Hotkeys: | | |
| Primary Softkey | ‘OK’ | |
| Secondary Softkey | ‘CANCL’ | |
| Link | None | |
| Back Key | No label | Inactive if possible. |
| | | Otherwise navigate to the Exit |
| | | Confirmation card |
| Home Key | No label | Exits the application without making |
| | | any updates |
| Scroll Up/Down | No label | Moves the cursor between the |
| | | editable fields |
| Page Up/Down | No label | Inactive if possible. |
| | | Otherwise navigate to |
| | | the Exit Confirmation card |
| Menu Key | No label | Inactive if possible. |
| | | Otherwise navigate to |
| | | the Exit Confirmation |
| | | card |
| Scroll Right/Left | No label | Moves the cursor one |
| | | character at a time |

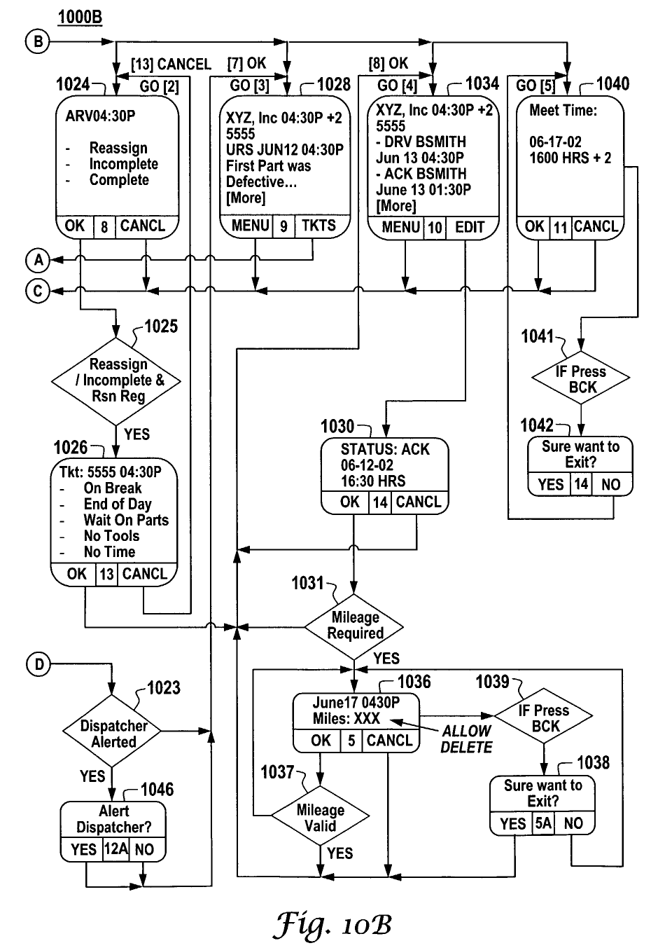

FIG. 11 is a pictorial diagram of a data-processing system 1100 in which a preferred embodiment of the present invention may be implemented. Data-processing system 1100 can be, for example, a personal computer or a computer workstation connected to at least one server. The present invention may be implemented on a variety of computers under a number of different operating systems. Data-processing system 1100 can also be implemented as a mainframe computer. Data-processing system 1100 may be, for example, a stand-alone system or part of a network such as a local area network (LAN) or a wide area network (WAN). Data-processing system 1100 generally includes a processor unit 1111, a keyboard 1112, a mouse 1130, and a graphic display (or monitor) 1140. Keyboard 1112, and mouse 1130 constitute user input devices, and graphic display 1140 constitutes an output device. Mouse 1130 can be utilized to control cursor 1150 displayed on screen 1160 of graphic display 1140. Data-processing system 1100 can support a graphical user interface (GUI), which allows a user to “point-and-select” by moving cursor 1150 to an icon or specific location on screen 1160 via mouse 1130 and then press one of the buttons on mouse 1130 to perform a user command.

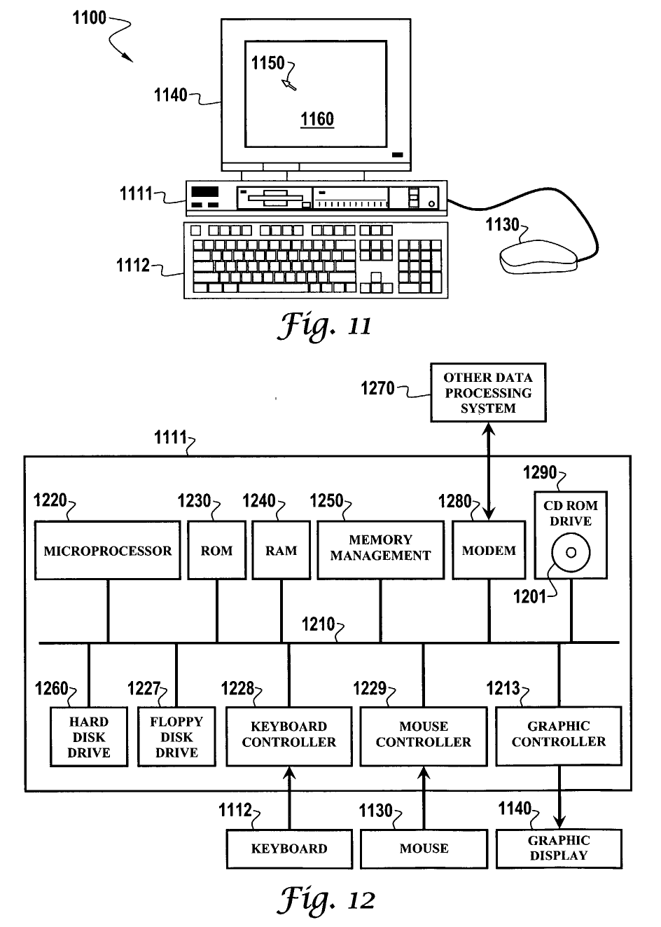

FIG. 12 illustrates a block diagram of the components for the data-processing system depicted in FIG. 11. Note that in FIGS. 11 and 12, like or analogous parts are indicated by identical reference numerals. Unit 1111 includes a system bus 1210 to which various components are attached and by which communications among various components is accomplished. A microprocessor 1220, connecting to system bus 1210, can be supported by read only memory (ROM) 1230 and random access memory (RAM) 1240, both of which are also connected to system bus 1210. ROM 1230 contains, among other codes, the Basic Input/Output System (BIOS), which controls certain basic hardware operations, such as interactions of hard disk drive 1260 and floppy disk drive 1227. RAM 1240 is the main memory within which the operating system and application programs are loaded. A memory management device 1250 is connected to system bus 1210 for controlling all Direct Memory Access (DMA) operations such as paging data between RAM 1240 and hard disk drive 1260 or floppy disk drive 1227.

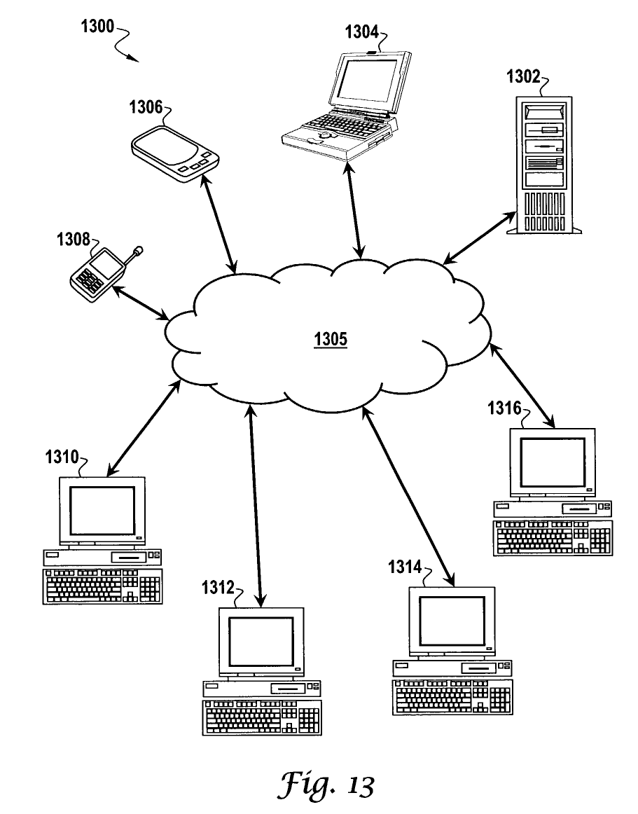

As illustrated in FIG. 12, a CD ROM drive 1290 having a compact disk 1201 inserted inside is installed within processor unit 1111. However, several other peripherals, such as optical storage media, printers, etc., may also be added to data-processing system 1100. Further, a modem 1280 may be utilized to communicate with other data processing systems 1270 across communications line 1265. It should be appreciated by those skilled in the art that modem 1280 can be provided in the form of wireless communication equipment used to communicate to public networks (e.g., CDMA, TDMA, GSM) or local wireless local area networks (e.g., WLANs) using Bluetooth and the 802.X family of wireless communication protocols. It should also be appreciated that processing unit 1111 can be provided in the form of a wireless, handheld unit such as a personal digital assistant (PDA), laptop or smartphone in communication with a wireless network (as explained and further illustrated with respect to FIG. 13). It can be assumed that the data-processing system illustrated in FIGS. 11 and 12 can be used to primarily handle the dispatcher operations described herein, while that a separate wireless PDA and/or web-browsing capable cellular telephone can handle the technician operations described herein.

Processor unit 1111 further comprises three input/output (I/O) controllers, namely, keyboard controller 1228, mouse controller 1229 and graphic controller 1213, all of which are connected system bus 1210. Keyboard controller 1228 provides the hardware interface for keyboard 1112. Mouse controller 1229 provides the hardware interface for mouse 1130, and graphic controller 1213 provides the hardware interface for graphic display 1140. The hardware setup illustrated in FIGS. 11 and 12 is typical but may vary for a specific application.

It has proven convenient at times by those skilled in the art, to refer to these signals as bits, values, elements, symbols, characters, terms, numbers, or the like. It should be borne in mind, however, that all of these and similar terms are to be associated with the appropriate physical quantities and are merely convenient labels applied to these quantities. Further, the manipulations performed are often referred to in terms, which are commonly associated with mental operations performed by a human operator. No such capability of a human operator is necessary or desirable in most cases of the operations described herein, which form part of the present invention. As indicated herein, these operations are primarily machine operations. Useful machines for performing operations of a preferred embodiment of the present invention include data-processing systems, such as a general-purpose digital computer or other similar devices. In all cases the distinction between the method of operations in operating a computer and the method of computation itself should be borne in mind.

The present invention relates to method steps for processing electrical or other (e.g. mechanical, chemical) physical signals to generate other desired physical signals, and can be implemented via a computer or microcomputer. It can be appreciated by those skilled in the art that the methods described herein can be implemented as a program product (e.g., a control program residing in a computer memory) containing instructions that when executed on a CPU, carry out the operations depicted in the logic flow diagrams herein. While the present invention is described in the context of a fully functional computer system, those skilled in the art can further appreciate that the present invention is capable of being distributed as a program product in a variety of forms, and that the present invention applies equally, regardless of the particular type of signal-bearing media utilized to actually carry out the distribution. Examples of signal-bearing media include recordable-type media, such as floppy disks, hard-disk drives and CD ROM's, and transmission-type media, such as digital and analog communication links. Such a program product may be processed via a processor such as microprocessor 1220, which is illustrated in FIG. 12 herein.

Preferred implementations of the invention can include implementations to execute the method or methods described herein as a program product residing in a memory of microcomputer. The program product thus includes sets of instructions for executing the method and system described herein. Until required by a microcomputer, the set of instructions may be stored as a computer-program product in another computer memory. For example, the set of instructions may be stored as a computer-program product in a disk drive attached to a microcomputer (which may include a removable memory such as an optical disk or floppy disk for eventual use in the disk drive).

The computer-program product can also be stored at another computer and transmitted, when desired, to a user's workstation by an internal or external network. Those skilled in the art can appreciate that the physical storage of the sets of instructions physically changes the medium upon which it is stored so that the medium carries computer-readable information. The change may be electrical, magnetic, chemical, or some other physical change. While it is convenient to describe the invention in terms of instructions, symbols, characters, or the like, the reader should remember that all of these and similar terms should be associated with the appropriate physical elements.

FIG. 13 depicts a client-server based system, which can be utilized in accordance with a preferred embodiment of the present invention. Thus, in one embodiment, shown in FIG. 13, the present invention may be performed through the implementation of a client-server based system 1300 over globally connected data networks, such as the Internet, wireless provider networks, and local area networks (wired and wireless). A server 1302 can communicate with each individual client such as a laptop computer 1304, a personal digital assistant (PDA) 1306, a cellular telephone 1308, and personal computers 1310, 1312, 1314, and 1316 via a network 1305. An example of network 1305 is the Internet, which is well known in the computer networking arts. Network 1305 may also be configured as a wireless network. There are many possible wireless network implementations of network 1305, which are described in further detail below. Server 1302 can also contain website information including web pages and documents written in HTML, ASP, XML, Perl, JavaScript, and the like, as well as application programs and databases to perform the invention. Server 1302 can be implemented as a single server a plurality of servers, which can communicate with one another. Server 1302 can function as a dispatch database, a dispatch application server, and/or a dispatch web server, as described herein. Thus, server 1302 can include a database (e.g., dispatch database), which contains work order information that can be retrieved by a user such as a dispatcher or a technician.

Clients such as a laptop computer 1304, a personal digital assistant (PDA) 1306, a cellular telephone 1308, and personal computers 1310, 1312, 1314, and 1316 can interact with at least one server over network 1305 to receive and transmit information between the client and the server. Clients 1304, 1306, 1308, 1310, 1312, 1314, and 1316 can be any type of computer or smart device with the capability to connect to a wireless network and/or computer network such as the Internet. These devices include, but are not limited to, desktop computers, laptop or notebook computers, cellar phones, smart phones, PCS phones, personal digital assistants (PDAs), two-way pagers, and the like. Note that the term “Internet” is well known in the art and thus a detailed explanation of the Internet is not necessary. Network 1305, however, can be implemented in the context of other types of communication networks, including wireless telecommunications networks. Network 1305 can, for example, be implemented as a wireless network. Note that the term “wireless network” as utilized herein can refer to wireless networks such as GPRS, HSCSD, GSM, CDPD, PCS, CDMA, 802.11x, Bluetooth and so forth.

Those skilled in the art can further appreciate that a variety of possible wireless communications and networking configurations may be utilized to implement network 1305. Network 1305 may be, for example, implemented according to a variety of wireless protocols, including satellite, cellular, and direct RF or IR communications. Satellite communications, for example, well known in the art and can be implemented in combination with a network. A hand held device can communicate with a POS, third-party provider of coupons/credits, retail establishment, or transaction broker to acquire, transmit, and negotiate coupon exchanges through network 1305. Network 1305 can be implemented as a single network type (e.g., Bluetooth) or a network based on a combination of network types (e.g., GSM, CDMA, etc).

Network 1305 can be configured as a CDPD (Cellular Digital Packet Data) network, well known in the networking arts. CDPD can be a TCP/IP based technology that supports Point-to-Point (PPP) or Serial Line Internet Protocol (SLIP) wireless connections to mobile devices, such as the hand held devices described and illustrated herein. Cellular service is generally available throughout the world from major service providers. Data can be transferred over switched PSTN circuits or packet-switched network utilizing CDPD protocols. Current restrictions of CDPD are not meant to limit the range or implementation of the method and system described herein, but are described herein for illustrative purposes only. It is anticipated that CDPD will be continually developed, and that such new developments can be implemented in accordance with the present invention.

Network 1305 can also be configured as a Personal Area Network. An example of a Personal Area Network (PAN) that may implemented in accordance with an alternative embodiment of the present invention is Bluetooth, which is well known in the telecommunications arts. Bluetooth was adopted by a consortium of wireless equipment manufacturers referred to at the Bluetooth Special Interest Group (BSIG), and has emerged as a global standard for low cost wireless data and voice communication. Current specifications for this standard call for a 2.4 GHz ISM frequency band. Bluetooth technology is generally based on a short-range radio transmitter/receiver built into small application specific circuits (ASICS) and embedded into support devices, such as the hand held devices described and illustrated herein.

The Bluetooth standard permits up to 100 mw of power, which can increase the range to 100 M. In addition, Bluetooth can support up to three voice channels. Utilizing short data packets and frequency hopping of up to 1600 hops per second, Bluetooth is a wireless technology that can be utilized to enable the implementation of the method and system described herein. Current restrictions of Bluetooth are not meant to limit the range or implementation of the present invention, but are described herein for illustrative purposes only. It is anticipated Bluetooth will be continually developed, and that such new developments can be implemented in accordance with the present invention.

Network 1305 can also be configured as a GSM network. GSM (Global System for Mobile Communication) and PCS (Personal Communications Systems) networks, both well known in the telecommunications arts, generally operate in the 800 MHz, 900 MHz, and 1900 MHz range. PCS initiates narrowband digital communications in the 900 MHz range for paging, and broadband digital communications in the 1900 MHz band for cellular telephone service. In the United States, PCS 1900 is equivalent to GSM 1900. GSM operates in the 900 MHz, 1800-1900 MHz frequency bands, while GSM 1800 is widely utilized throughout Europe and many other parts of the world.

In the United States, GSM 1900 is equivalent to PCS 1900, thereby enabling the compatibility of these two types of networks. Current restrictions of GSM and PCS are not meant to limit the range or implementation of the present invention, but are described herein for illustrative purposes only. It is anticipated that GSM and PCS will be continually developed, and that such new developments can be implemented in accordance with the present invention.

Network 1305 can be also implemented as a GPRS network. GPRS technology, well-known in the telecommunications arts, bridges the gap between current wireless technologies and the so-called “next generation” of wireless technologies referred to frequently as the third-generation or 3G wireless technologies. GPRS is generally implemented as a packet-data transmission network that can provide data transfer rates up to 115 Kbps. GPRS can be implemented with CDMA and TDMA technology and supports X.25 and IP communications protocols, all well known in the telecommunications arts. GPRS also enables features, such as Voice over IP (VOIP) and multimedia services. Current restrictions of GPRS are not meant to limit the range or implementation of the present invention, but are described herein for illustrative purposes only. It is anticipated that GPRS will be continually developed and that such new developments can be implemented in accordance with the present invention.

Network 1305 can be implemented as a CDMA wireless network. CDMA (Code Division Multiple Access) is a protocol standard based on IS-95 CDMA, also referred to frequently in the telecommunications arts as CDMA-1. IS-95 CDMA is generally configured as a digital wireless network that defines how a single channel can be segmented into multiple channels utilizing a pseudo-random signal (or code) to identify information associated with each user. Because CDMA networks spread each call over more than 4.4 trillion channels across the entire frequency band, it is much more immune to interference than most other wireless networks and generally can support more users per channel.

Network 1305 can also be configured with a form of CDMA technology known as wideband CDMA (W-CDMA). Wideband CDMA is also referred to as CDMA 2000 in North America. W-CDMA can be utilized to increase transfer rates utilizing multiple 1.25 MHz cellular channels. Current restrictions of CDMA and W-CDMA are not meant to limit the range or implementation of the present invention, but are described herein for illustrative purposes only. It is anticipated that CDMA and W-CDMA will be continually developed and that such new developments can be implemented in accordance with the present invention.

Network 1305 can be also implemented as a paging network. Such paging networks, well known in the telecommunications arts, can be implemented in accordance with the present invention to enable transmission or receipt of data over the TME/X protocol, also well known in the telecommunications arts. Such a protocol enables notification in messaging and two-way data coverage utilizing satellite technology and a network of base stations geographically located throughout a particular geographical region. A paging network can be configured to process enhanced messaging applications.

Unified messaging solutions can be utilized in accordance with network 1305 (i.e., a wireless network) to permit carriers and Internet service providers to manage client e-mail, voice messages and fax images and can facilitate delivery of these communications to PDAs, telephony devices, pagers, personal computers and other capable information retrieval devices, wired or wireless. Current restrictions of such paging networks are not meant to limit the range or implementation of the present invention, but are described herein for illustrative purposes only. It is anticipated that such paging networks, including those based on the TME/X protocol, will be continually developed and that such new developments can be implemented in accordance with the present invention.

Network 1305 can also be configured as a TDMA network. TDMA (Time Division Multiple Access) is a telecommunications network utilized to separate multiple conversation transmissions over a finite frequency allocation of through-the-air bandwidth. TDMA can be utilized in accordance with the present invention to allocate a discrete amount of frequency bandwidth to each user in a TDMA network to permit many simultaneous conversations or transmission of data. Each user is assigned a specific timeslot for transmission. A digital cellular communications system that utilizes TDMA typically assigns 10 timeslots for each frequency channel.

A hand held device operating in association with a TDMA network sends bursts or packets of information during each timeslot. The receiving equipment into the original voice or data/information components can then reassemble such packets of information. Current restrictions of such TDMA networks are not meant to limit the range or implementation of the present invention, but are described herein for illustrative purposes only. It is anticipated that TDMA networks will be continually developed and that such new developments can be implemented in accordance with the present invention.

Network 1305 can also be configured as a WIN (Wireless Intelligent Network). WIN is generally known as the architecture of the wireless switched network that allows carriers to provide enhanced and customized services for mobile telephones. Intelligent wireless networks generally include the use of mobile switching centers (MSCs) having access to network servers and databases such as Home Location Registers (HLRS) and Visiting Location Registers (VLRs), for providing applications and data to networks, service providers and service subscribers (wireless device users).

Local number portability allows wireless subscribers to make and receive calls anywhere—regardless of their local calling area. Roaming subscribers are also able to receive more services, such as call waiting, three-way calling and call forwarding. A HLR is a database that contains semi permanent mobile subscriber (wireless device user) information for wireless carriers' entire subscriber base. HLR subscriber information includes identity, service subscription information, location information (the identity of the currently serving VLR to enable routing of communications), service restrictions and supplementary services/information. HLRs handle SS7 transactions in cooperation with Mobile Switching Centers and VLR nodes, which request information from the HLR or update the information contained within the HLR. The HLR also initiates transactions with VLRs to complete incoming calls and update subscriber data. Traditional wireless network design is based on the utilization of a single HLR for each wireless network, but growth considerations are prompting carriers to consider multiple HLR topologies.

The VLR is also a database that contains temporary information concerning the mobile subscribers currently located in a given MSC serving area, but whose HLR is elsewhere. When a mobile subscriber roams away from the HLR location into a remote location, SS7 messages are used to obtain information about the subscriber from the HLR, and to create a temporary record for the subscriber in the VLR. Signaling System No. 7 (referred to as SS7 or C7) is a global standard for telecommunications. In the past the SS7 standard has defined the procedures and protocol by which network elements in the public switched telephone network (PSTN) exchange information over a digital signaling network to effect wireless and wireline call setup, routing, control, services, enhanced features and secure communications. Such systems and standards may utilized to implement network 1305, in accordance with the present invention.

Improved operating systems and protocols allow graphical user interfaces (GUIs) to provide an environment that displays user options (e.g., graphical symbols, icons or photographs) on a wireless device's screen. Extensible Markup Language (“XML”) is a currently available standard that performs as a universal language for data, making documents more interchangeable. XML allows information to be used in a variety of formats for different devices, including PCs, PDAs and web-enabled mobile phones. XML enables documents to be exchanged even where the documents were created and/or are generally used by different software applications. XML may effectively enable one system to translate what another systems sends. As a result of data transfer improvements, wireless device GUIs can be utilized in accordance with a hand held device and network 1305 (i.e., a wireless network), whether configured as a paging network or another network type, to render images on the hand held device that closely represent the imaging capabilities available on desktop computing devices.

The embodiments and examples set forth herein are presented to best explain the present invention and its practical application and to thereby enable those skilled in the art to make and utilize the invention. Those skilled in the art, however, can recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A system for managing dispatched services through a wireless network, comprising:
a server, wherein said server manages communication between at least one dispatcher and at least one dispatched technician;
a database associated with said server, wherein said database stores work order information;
a dispatcher workstation in communication with said database and said server, wherein said dispatcher workstation comprises a display screen; and
a graphical user interface displayable on said display screen, wherein said graphical user interface permits a dispatcher to perform, utilizing said dispatcher workstation, at least one of the following: entering said work order information, modifying said work order information, transmitting said work order information to a dispatched technician, receiving said work order information from a dispatched technician; and communicating with a dispatched technician.

2. The system of claim 1, further comprising a mobile device interface including a display screen and a mobile wireless device, wherein said mobile device interface permits a dispatched technician to perform at least one of the following: remotely accessing said server, remotely accessing said database, retrieving said work order information from said database, entering said work order information into said database, transmitting said work order information to said dispatcher, receiving said work order information from said dispatcher, and communicating with said dispatcher.

3. The system of claim 1 wherein said work order information includes meeting time and date information.

4. The system of claim 2 wherein said work order information includes meeting time and date information.

5. The system of claim 3 wherein said work information includes customer information, including customer location and customer identification information.

6. The system of claim 4 wherein said work information includes customer information, including customer location and customer identification information.

7. The system of claim 1 further comprising:
an authentication module, wherein said dispatcher is provided access to said server only after being authenticated by said authentication module in response to an input by said dispatcher at said workstation.

8. The system of claim 2 further comprising:
an authentication module, wherein said dispatched technician is provided access to said server only after being authenticated by said authentication module in response to an input by said dispatched technician at said mobile interface unit.

9. The system of claim 2, wherein said mobile interface unit comprises a mobile wireless device.

10. The method of claim 9 wherein said mobile wireless device further comprises a cellular telephone.

11. The system of claim 9 wherein said mobile wireless device comprises a PDA.

12. The system of claim 1, wherein said database comprises a dispatch database.

13. The system of claim 1 wherein said server comprises a dispatch web server.

14. The system of claim 1 wherein said server comprises a dispatch application server.

15. A method for managing dispatched services through a wireless network, comprising:
accessing a database via a server, wherein said database stores work order information; and
performing at least one of the following: entering said work order information into said database, transmitting said work order information to a dispatched technician through a wireless network, and receiving said work order information from a dispatched technician through said wireless network.

16. The method of claim 15 further comprising the step of:
accessing said database by said dispatcher utilizing said graphical user interface associated with a data processor.

17. The method of claim 16 further comprising the step of:
providing access to said database by said technician utilizing said mobile device interface.

18. The method of claim 15 wherein said work order information includes meeting time and date information.

19. The method of claim 15 wherein said work information includes customer information, including customer location and customer identification information.

20. The method of claim 16 further comprising the step of:
permitting said dispatcher to access said graphical user interface, only after authentication of said dispatcher.

21. The method of claim 17 further comprising the step of:
permitting said technician to access said server using said mobile device interface, only after authentication of said dispatched technician.

22. The method of claim 15 further comprising the step of:
editing said work order information in response to an input by said technician via said mobile device interface.

23. The method of claim 15 further comprising the step of:
editing said work order information in response to an input by said dispatcher via said graphical user interface.

24. The method of claim 15 further comprising the step of:
providing at least one ticket in the form of at least one card displayable via said mobile device interface, wherein ticket includes said work order information.

25. The method of claim 15 wherein said database comprises a dispatch database.

26. The method of claim 25 wherein said server comprises a dispatch web server.

27. The method of claim 25 wherein said server comprises a dispatch application server.

28. The method of claim 16 wherein said graphical user interface permits said dispatcher to enter standard comments, reason codes, and system parameters associated with said work order information.

29. A method for managing a dispatched services through a wireless network, comprising:
accessing a server from a remote mobile interface through a wireless network, said server having access to a database storing work order information; and
performing at least one of: receiving work order information from a dispatcher, transmitting work order information to a dispatcher, and entering work order information into said database.

30. The method of claim 29 further comprising the step of:
accessing said server utilizing a mobile device interface.

31. The method of claim 29 wherein said work order information includes meeting time and date information.

32. The method of claim 30 wherein said work order information includes meeting time and date information.

33. The method of claim 29 wherein said work information includes customer information, including customer location and customer identification information.

34. The method of claim 29 further comprising the step of:
access said server only in response to a user authentication.

35. The method of claim 29 further comprising the step of:
editing said work order information in response to an input by said technician via said mobile device interface.

36. The method of claim 29 further comprising the step of:
receiving at least one ticket in the form of at least one card displayable via said mobile device interface, wherein at least one ticket includes said work order information.

37. The method of claim 29 wherein said mobile device interface includes a mobile wireless device.

38. The method of claim 29 wherein said mobile wireless device further comprises a cellular telephone.

39. The method of claim 29 wherein said mobile wireless device further comprises a PDA.

40. The method of claim 29 wherein said mobile device interface further permits said technician to acknowledge a dispatch, indicate a drive status and an arrival status, complete or incomplete a ticket, reschedule a work order, and add comments thereof.
